(19) United States
(12) Patent Application Publication
(10) Pub. No.: US 2025/0003932 A1
(43) Pub. Date: Jan. 2, 2025

(54) METHOD FOR DETERMINING LIFETIME OF AT LEAST ONE CHROMATOGRAPHY COLUMN

(71) Applicant: Roche Diagnostics Operations, Inc., Indianapolis, IN (US)

(72) Inventors: Ruediger Laubender, Pullach im Isartal (DE); Stefan Quint, München (DE); Marius Wagner, München (DE)

(21) Appl. No.: 18/294,945

(22) PCT Filed: Aug. 1, 2022
(86) PCT No.: PCT/EP2022/071568

§ 371 Date: Feb. 2, 2024

(30) Foreign Application Priority Data
Aug. 2, 2021 (EP) 21189139.5

(51) Int. Cl. G01N 30/86; G01N 30/02

(52) U.S. Cl. CPC G01N 30/8693; G01N 2030/027

(57) ABSTRACT

A computer implemented method (140) for determining lifetime of at least one chromatography column (116) of at least one chromatography device (110), wherein the method (140) comprises the following steps:
i) receiving model input chromatography data via at least one communication interface (128);
ii) determining at least one state variable indicative of lifetime of the chromatography column (116) using at least one data driven model based on the model input chromatography data using at least one processing device (130);
iii) evaluating the determined state variable thereby determining information about lifetime by using the processing device (130), wherein the evaluation comprises comparing the determined state variable to at least one threshold.

Further, a test system (112), a computer program and a method for operating a chromatography column (116) are disclosed.

### TECHNICAL FIELD

The present invention relates to a method for determining lifetime of at least one chromatography column of at least one chromatography device, a test system configured for performing said method, a method for operating a chromatography column and computer programs.

### BACKGROUND ART

In-vitro diagnostics (IVD) instruments may use chromatography separation, such as high performance liquid chromatography (HPLC) or Rapid liquid chromatography (Rapid LC), of analytes before they are measured by means of mass spectrometry (MS). Columns of said Rapid LC or HPLC usually are exchanged on a regular basis by a customer. The lifetime expectancy may depend on the respective use-case. For example, current lifetime expectancy is about 5000 injections taking into account deterioration and contamination of the column. However, due to the high costs of the columns they make up the major part of the overall assay costs. The column needs to be exchanged prior to its failure to ensure the uninterrupted workflow and throughput of samples in the laboratory. The gradual deterioration of HPLC or Rapid LC columns in liquid chromatography (LC)/MS systems is a naturally occurring phenomena. A column failure may lead to low performant or even false measurements which is critical especially in the in-vitro diagnostics (IVD) environment.

As column lifetime is influenced by random factors, there is a risk that unforeseeable column exchange events may occur which are undesired as the system down-time will decrease through-put. To reduce the occurrence of such unforeseeable events a more frequent exchange may be performed, however, also a too early exchange is undesired as the columns are costly items. To address both, unexpected column failure and as low as possible exchange frequency, prediction of column lifetime would be beneficial. However, conventional statistical approaches or simple counters are expected not to perform well as they disregard individual column, chromatography device and laboratory or environmental factors.

U.S. Pat. No. 5,670,379 A describes a chromatograph system in which a regression line is set between retention times of predetermined peaks measured at each run in the past for a standard sample having known components. Referring to this regression line, the peak identifying condition, i.e., time window, is corrected.

### Problem to be Solved

It is therefore desirable to provide a method and a system for determining lifetime of at least one chromatography column of at least one chromatography device which at least partially address the above-mentioned technical challenges. Specifically, it is desirable to provide a method and a system for determining lifetime of at least one chromatography column of at least one chromatography device which allow for enhanced reliability and accuracy, and therefore optimized through-put and patient safety, and at the same time reduced costs.

### SUMMARY

This problem is addressed by methods and a test device with the features of the independent claims. Advantageous embodiments which might be realized in an isolated fashion or in any arbitrary combinations are listed in the dependent claims as well as throughout the specification.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

As used herein, the term “standard conditions”, if not otherwise noted, relates to IUPAC standard ambient temperature and pressure (SATP) conditions, i.e. preferably, a temperature of 25° C. and an absolute pressure of 100 kPa; also preferably, standard conditions include a pH of 7. Moreover, if not otherwise indicated, the term “about” relates to the indicated value with the commonly accepted technical precision in the relevant field, preferably relates to the indicated value±20%, more preferably #10%, most preferably ±5%. Further, the term “essentially” indicates that deviations having influence on the indicated result or use are absent, i.e potential deviations do not cause the indicated result to deviate by more than ±20%, more preferably ±10%, most preferably ±5%. Thus, “consisting essentially of” means including the components specified but excluding other components except for materials present as impurities, unavoidable materials present as a result of processes used to provide the components, and components added for a purpose other than achieving the technical effect of the invention. For example, a composition defined using the phrase “consisting essentially of” encompasses any known acceptable additive, excipient, diluent, carrier, and the like. Preferably, a composition consisting essentially of a set of components will comprise less than 5% by weight, more preferably less than 3% by weight, even more preferably less than 1% by weight, most preferably less than 0.1% by weight of non-specified component(s).

The methods described herein are in vitro methods. The methods, such as at least one step or all method steps, may be assisted or performed by automated equipment. Specifically, the whole methods may be implemented on such automated equipment; e.g. on a chromatographic analysis system. The steps described may, as far as technically possible, be performed in any arbitrary order, however, in a further embodiment, are performed in the given order. Moreover, the methods may comprise steps in addition to those explicitly mentioned above.

In a first aspect of the present invention a computer implemented method for determining lifetime of at least one chromatography column of at least one chromatography device is proposed.

The term “computer implemented method” as used herein is a broad term and is to be given its ordinary and customary meaning to a person of ordinary skill in the art and is not to be limited to a special or customized meaning. The term specifically may refer, without limitation, to a method involving at least one computer and/or at least one computer network. The computer and/or computer network may comprise at least one processor which is configured for performing at least one of the method steps of the method according to the present invention. Preferably each of the method steps is performed by the computer and/or computer network. The method may be performed completely automatically, specifically without user interaction. The term “automatically” as used herein is a broad term and is to be given its ordinary and customary meaning to a person of ordinary skill in the art and is not to be limited to a special or customized meaning. The term specifically may refer, without limitation, to a process which is performed completely by means of at least one computer and/or computer network and/or machine, in particular without manual action and/or interaction with a user.

The term “chromatography column” as used herein is a broad term and is to be given its ordinary and customary meaning to a person of ordinary skill in the art and is not to be limited to a special or customized meaning. The term specifically may refer, without limitation, to a, typically cylindrical, container comprising a stationary phase and having an inlet and an outlet for a mobile phase, e.g. a liquid, a gas, an aqueous chromatography solvent. For example, the chromatography column is a liquid chromatography (LC) column.

For example, the chromatography column is a high-performance liquid chromatography (HPLC) or fast-performance liquid chromatography (FPLC) or rapid liquid chromatography column. Appropriate stationary phase materials and mobile phases and their combinations are known in the art.

The chromatography device, for example, may comprise at least one liquid chromatography device. The liquid chromatography device may be or may comprise at least one high-performance liquid chromatography (HPLC) device or at least one micro liquid chromatography (uLC) device. The chromatography device may be coupled, for example via at least one interface, to a mass spectrometry device. As used herein, the term “chromatography device” is a broad term and is to be given its ordinary and customary meaning to a person of ordinary skill in the art and is not to be limited to a special or customized meaning. The term specifically may refer, without limitation, to an analytical module configured to separate one or more analytes of interest of the sample from other components of the sample for detection of the one or more analytes with the mass spectrometry device. The chromatography device may comprise at least one chromatography column. For example, the chromatography device may be a single-column device or a multi-column device having a plurality of columns. The chromatography column may have a stationary phase through which a mobile phase is pumped in order to separate and/or elute and/or transfer the analytes of interest. As used herein, the term “mass spectrometry device” is a broad term and is to be given its ordinary and customary meaning to a person of ordinary skill in the art and is not to be limited to a special or customized meaning. The term specifically may refer, without limitation, to a mass analyzer configured for detecting at least one analyte based on mass to charge ratio. The mass spectrometry device may be or may comprise at least one quadrupole mass spectrometry device. The interface coupling the chromatography device and the mass spectrometry device may comprise at least one ionization source configured for generating of molecular ions and for transferring of the molecular ions into the gas phase.

20) The term “analyte”, as used herein, relates to any chemical compound or group of compounds which shall be determined in a sample. For example, the analyte may be a macromolecule, i.e. a compound with a molecular mass of more than 1000 u (i.e. more than 1 kDa). For example, the analyte is a biological macromolecule, in particular a polypeptide, a polynucleotide, a polysaccharide, or a fragment of any of the aforesaid. For example, the analyte is a small molecule chemical compound, i.e. a compound with a molecular mass of at most 1000 u (1 kDa). For example, the analyte is a chemical compound metabolized by a body of a subject, in particular of a human subject, or is a compound administered to a subject in order to induce a change in the subject's metabolism. Thus, for example, the analyte is a drug of abuse or a metabolite thereof, e.g. amphetamine; cocaine; methadone; ethyl glucuronide; ethyl sulfate; an opiate, in particular buprenorphine, 6-monoacatylmorphine, codeine, dihydrocodeine, morphine, morphine-3-glucuronide, and/or tramadol; and/or an opioid, in particular acetylfentanyl, carfentanil, fentanyl, hydrocodone, norfentanyl, oxycodone, and/or oxymorphone.

For example, the analyte is a therapeutic drug, e.g. valproic acid; clonazepam; methotrexate; voriconazole; mycophenolic acid (total); mycophenolic acid-glucuronide; acetaminophen; salicylic acid; theophylline; digoxin; an immuno suppressant drug, in particular cyclosporine, everolimus, sirolimus, and/or tacrolimus; an analgesic, in particular meperidine, normeperidine, tramadol, and/or O-desmethyl-tramadol; an antibiotic, in particular gentamycin, tobramycin, amikacin, vancomycin, piperacilline (tazobactam), meropenem, and/or linezolid; an antieplileptic, in particular phenytoin, valporic acid, free phenytoin, free valproic acid, levetiracetam, carbamazepine, carbamazepine-10,11-epoxide, phenobarbital, primidone, gabapentin, zonisamid, lamotrigine, and/or topiramate. For example, the analyte is a hormone, in particular cortisol, estradiol, progesterone, testosterone, 17-hydroxyprogesterone, aldosterone, dehydroepiandrosteron (DHEA), dehydroepiandrosterone sulfate (DHEA-S), dihydrotestosterone, and/or cortisone; for example, the sample is a serum or plasma sample and the analyte is cortisol, DHEA-S, estradiol, progesterone, testosterone, 17-hydroxyprogesterone, aldosterone, DHEA, dihydrotestosterone, and/or cortisone; for example, the sample is a saliva sample and the analyte is cortisol, estradiol, progesterone, testosterone, 17-hydroxyprogesterone, androstendione, and/or cortisone; for example, the sample is a urine sample and the analyte is cortisol, aldosterone, and/or cortisone. For example, the analyte is a vitamin, for example vitamin D, in particular ergocalciferol (Vitamin D2) and/or cholecalciferol (Vitamin D3) or a derivative thereof, e.g. 25-hydroxy-vitamine-D2, 25-hydroxy-vitamine-D3, 24,25-dihydroxy-vitamine-D2, 24,25-dihydroxy-vitamine-D3, 1,25-dihydroxy-vitamine-D2, and/or 1,25-dihydroxy-vitamine-D3. For example, the analyte is a metabolite of a subject.

As used herein, the term “sample”, also referred to as “test sample”, may relate to any type of composition of matter; thus, the term may refer, without limitation, to any arbitrary sample such as a biological sample. For example, the sample is a liquid sample, e.g. an aqueous sample. For example, the test sample is selected from the group consisting of: a physiological fluid, including whole blood, serum, plasma, saliva, ocular lens fluid, lacrimal fluid, cerebrospinal fluid, sweat, urine, milk, ascites, mucus, synovial fluid, peritoneal fluid, and amniotic fluid; lavage fluid; tissue, cells, or the like. The sample may, however, also be a natural or industrial liquid, in particular surface or ground water, sewage, industrial wastewater, processing fluid, soil eluates, and the like. For example, the sample comprises or is suspected to comprise at least one chemical compound of interest, i.e. a chemical which shall be determined, which is referred to as “analyte”. The sample may comprise one or more further chemical compounds, which are not to be determined and which are commonly referred to as matrix, as specified herein above. The sample may be used directly as obtained from the respective source or may be subjected to one or more pretreatment and/or a sample preparation step(s). Thus, the sample may be pretreated by physical and/or chemical methods, for example by centrifugation, filtration, mixing, homogenization, chromatography, precipitation, dilution, concentration, contacting with a binding and/or detection reagent, and/or any other method deemed appropriate by the skilled person. In, i.e. before, during, and/or after, the sample preparation step, one or more internal standard(s) may be added to the sample. The sample may be spiked with the internal standard. For example, an internal standard may be added to the sample at a predefined concentration. The internal standard may be selected such that it is easily identifiable under normal operating conditions of the detector chosen, e.g. a mass spectrometry device, a photometric cell, e.g. in an UV-Vis spectroscopic device, an evaporative light scattering refractometer, a conductometer, or any device deemed appropriate by the skilled person. The concentration of the internal standard may be pre-determined and significantly higher than the concentration of the analyte.

The term “lifetime” of a chromatography column is a broad term and is to be given its ordinary and customary meaning to a person of ordinary skill in the art and is not to be limited to a special or customized meaning. The term specifically may refer, without limitation, to a parameter indicative of wear inflicted on a chromatography column by past separations performed thereon. For example, the lifetime is a remaining useful lifetime (RUL), i.e. a parameter indicative of how many separations are expected to be possible using the chromatography column before column performance becomes inacceptable. For example, the lifetime is a spent lifetime, i.e. a parameter indicative of how many separations were already performed using the chromatography column. Thus, the lifetime may be indicated as a number of remaining runs in the case of a remaining lifetime, or may be a number of cumulated runs in the case of a spent lifetime. It is, however, also envisaged that the lifetime is an abstract value; e.g. a lifetime may also be indicated as a calculated fraction of initial performance or as a lifetime score, for example with arbitrary units, or any other parameter deemed appropriate by the skilled person. The lifetime of a chromatography column, as is understood by the skilled person, may be a column-specific parameter. The lifetime of a chromatography column, for example, further is a protocol-specific, for example assay-specific, parameter; i.e., for example, different protocols, in particular assays, vary in how demanding they are with regards to column performance and, therefore, the value of the lifetime may be different for different protocols and/or assays. Thus, a chromatography column may have reached the end of its remaining lifetime for a demanding assay, while it may still be usable in a less demanding assay.

The determining a lifetime may comprise predicting lifetime over subsequent chromatographic separations such as over the next 5, preferably the next 10, more preferably the next 35, chromatographic separations. The predicted lifetime corresponding to a number of 35, 65, 130 or even 265 chromatographic separations may be dependent on a number of streams in the system and/or on a length of the chromatographic method. For example, a chromatographic separation on the chromatography column may have a length of 108 s. In this example, a number of 33.33 chromatographic separations may be performed per hour on the chromatography column. However, as an example, for a three stream system, a number of 100 injections may be performed per hour.

The method may comprise operating the chromatography column. The term “operating a chromatography column” is a broad term and is to be given its ordinary and customary meaning to a person of ordinary skill in the art and is not to be limited to a special or customized meaning. The term specifically may refer, without limitation, to a single or multiple use of a chromatography column for a chromatographic separation. For example, the term may relate to a use of a chromatography column for a series of chromatographic separations, wherein said chromatographic separations may be separations according to the same protocol, or according to different protocols. The term “chromatography protocol”, also referred to as “protocol”, relates to the sum of chromatography parameters applied to a chromatography column, i.e, in particular the specific mobile phase or gradient thereof, temperature, pressure, flow rate, and sample type. The term “assay”, as used herein, relates to the sum of parameters defining a protocol, further including the chromatography column to be used and the analysis to be performed, in particular the analyte(s) to be determined, as well as sample preparation steps, such as those specified elsewhere herein. Thus, on a specific chromatography column, it is, in principle, possible to detect several non-identical analytes using the same protocol, i.e. to use the same protocol for more than one non-identical assay. It is, however, also possible to detect the same analyte with different protocols. As is clear from the above, using different protocols for the detection of the same analyte(s), as well as using the same protocol for detecting different analyte(s), in each case defines a specific assay. In contrast, the term “separation”, which may also be referred to as “run” or “injection”, or “measurement”, relates to a single event of performing a chromatography using a specific chromatography column, for example independent of protocol and/or assay. Nonetheless, a separation is typically performed using one specific protocol and is performed in the context of a particular assay.

The method comprises the following steps which, as an example, may be performed in the given order. It shall be noted, however, that a different order is also possible. Further, it is also possible to perform one or more of the method steps once or repeatedly. Further, it is possible to perform two or more of the method steps simultaneously or in a timely overlapping fashion. The method may comprise further method steps which are not listed.

The method comprises the following steps:
i) receiving model input chromatography data via at least one communication interface;
ii) determining at least one state variable indicative of lifetime of the chromatography column using at least one data driven model based on the model input chromatography data using at least one processing device;
iii) evaluating the determined state variable thereby determining information about lifetime by using the processing device, wherein the evaluation comprises comparing the determined state variable to at least one threshold.

The method steps i) to iii) may be performed fully automatic, specifically using the processing device. The term “processing device” as used herein is a broad term and is to be given its ordinary and customary meaning to a person of ordinary skill in the art and is not to be limited to a special or customized meaning. The term specifically may refer, without limitation, to an arbitrary logic circuitry configured for performing basic operations of a computer or system, and/or, generally, to a device which is configured for performing calculations or logic operations. In particular, the processing device may be configured for processing basic instructions that drive the computer or system. As an example, the processing device may comprise at least one arithmetic logic unit (ALU), at least one floating-point unit (FPU), such as a math coprocessor or a numeric coprocessor, a plurality of registers, specifically registers configured for supplying operands to the ALU and storing results of operations, and a memory, such as an L1 and L2 cache memory. In particular, the processing device may be a multicore processor. Specifically, the processing device may be or may comprise a central processing unit (CPU) or graphics processing unit (GPU), or tensor processing unit (TPU). Additionally or alternatively, the processing device may be or may comprise a microprocessor, thus specifically the processing device's elements may be contained in one single integrated circuitry (IC) chip. Additionally or alternatively, the processing device may be or may comprise one or more application specific integrated circuits (ASICs) and/or one or more field-programmable gate arrays (FPGAs) or the like.

The method can be automatized on a fully automated MS based analyzer and thus, measurement errors can be avoided automatically reducing system down-time and costs.

The term “communication interface” as used herein is a broad term and is to be given its ordinary and customary meaning to a person of ordinary skill in the art and is not to be limited to a special or customized meaning. The term specifically may refer, without limitation, to an item or element forming a boundary configured for transferring information. In particular, the communication interface may be configured for transferring information from a computational device, e.g. a computer, such as to send or output information, e.g. onto another device. Additionally or alternatively, the communication interface may be configured for transferring information onto a computational device, e.g. onto a computer, such as to receive information. The communication interface may specifically provide means for transferring or exchanging information. In particular, the communication interface may provide a data transfer connection, e.g. Bluetooth, NFC, inductive coupling or the like. As an example, the communication interface may be or may comprise at least one port comprising one or more of a network or internet port, a USB-port and a disk drive. The communication interface may be at least one web interface.

The term “chromatography data” as used herein is a broad term and is to be given its ordinary and customary meaning to a person of ordinary skill in the art and is not to be limited to a special or customized meaning. The term specifically may refer, without limitation, to data determined by operating the chromatography column and/or readbacks such as prints.

The term “model input chromatography data” as used herein is a broad term and is to be given its ordinary and customary meaning to a person of ordinary skill in the art and is not to be limited to a special or customized meaning. The term specifically may refer, without limitation, to input data for the data driven model. The model input chromatography data may comprise at least one arbitrary feature derived from at least one input variable and/or at least one state variable. For example, the model input chromatography data may comprise at least one feature derived from at least one input variable selected from the group consisting of standard deviation, mean absolute deviation, median, quantiles, kurtosis, maximum, minimum, auto-correlation coefficient, linear-trend, fast Fourier coefficient, number of peaks, and the like. For example, the state variable may be one or more of running time of the chromatography column, solvent volumes that have run over the chromatography column, operating temperature of the chromatography column, sample matrices, e.g. urine, whole blood, spinal fluid, flow rate of HPLC. For example, the model input chromatography data may comprise at least one input parameter selected from the group consisting of: maximum pressure, pressure difference at start and end of a chromatogram, peak width, retention time, peak symmetry, sample type, assay type of each measurement, usage time of the chromatography column on the chromatography device, at least one maintenance parameter e.g. relating to column care, change of chromatography column. For example, the model input chromatography data may comprise at least one input parameter of maximum pressure, peak width and retention time.

The model input chromatography data comprises multiple inputs. The model input chromatography data may comprise a plurality of features derived from a plurality of input variables and/or state variables. For example, the model input chromatography data may comprise a plurality of features derived from input variables selected from the group consisting of standard deviation, mean absolute deviation, median, quantiles, kurtosis, maximum, minimum, auto-correlation coefficient, linear-trend, fast Fourier coefficient, number of peaks, and the like. For example, the state variables may be selected from running time of the chromatography column, solvent volumes that have run over the chromatography column, operating temperature of the chromatography column, sample matrices, e.g. urine, whole blood, spinal fluid, flow rate of HPLC. For example, the model input chromatography data may comprise a plurality of input parameters selected from the group consisting of: maximum pressure, pressure difference at start and end of a chromatogram, peak width, retention time, peak symmetry, sample type, assay type of each measurement, usage time of the chromatography column on the chromatography device, at least one maintenance parameter e.g. relating to column care, change of chromatography column. For example, the model input chromatography data may comprise as input parameters maximum pressure, peak width and retention time. In contrast to known methods, e.g. as described in U.S. Pat. No. 5,670,379 A, the model input chromatography data may comprise multiple inputs. This can allow significantly improving the prediction U.S. Pat. No. 5,670,379 A, only uses a single input, in particular pressure or peak width or retention time or lamp intensity or detector noise/drift. Such an approach, however, may be problematic in view of robustness towards noise.

The term “sample type”, as used herein, may include each and every parameter influencing the type and amount of sample constituents. For example, the sample type is defined at least 20) by sample matrix and pre-purification state of said sample. The term “sample matrix” is known to relate to the entirety of non-analyte constituents of a sample; sample matrix is, for example, defined by sample origin, e.g., for example, as a bodily fluid sample, such as whole blood, serum, plasma, urine, saliva, or sputum; or as a tissue sample, such as biopsy material. The term “pre-purification state” of a sample relates the entirety of measures applied to a sample after it was obtained, which at least partially remove sample constituents, in particular matrix constituents. Pre-purification steps are known in the art and include in particular centrifugation, precipitation, solvent treatment, extraction, homogenization, heat treatment, freezing and thawing, lysis of cells, application to a pre-column, and the like, for example as specified elsewhere herein. As will be understood from the above, as used herein, any differences in pre-purification steps causing sample constituents to differ, e.g., are considered to provide different sample types; thus, e.g. a low-speed centrifuged serum sample and an ultracentrifuged serum sample may be different sample types.

The model input chromatography data may comprise metadata relating to one or more of at least one chromatography column production factor, at least one laboratory specific factor. The metadata may relate to arbitrary data for a new chromatography column provided by a manufacturer, e.g. via a barcode, RFID or other data carrier. For example, the metadata may comprise one or more of column dimensions, e.g. length, width, diameter such as inner and/or outer diameter, inner volume, inner surface, information about lot, manufacturer, installation time.

As used herein, the term “receiving of model input chromatography data” is a broad term and is to be given its ordinary and customary meaning to a person of ordinary skill in the art and is not to be limited to a special or customized meaning. The term specifically may refer, without limitation, to one or more of receiving, downloading, accessing, determining, measuring, detecting, and recording the model input chromatography data. For example, the model input chromatography data may be retrieved by downloading and/or accessing the model input chromatography data from at least one database such as of a detector or of a cloud. For example, the method may comprise measuring using the chromatography in step i). Specifically, the model input chromatography data may be retrieved by performing at least one chromatography run.

The method may comprise receiving raw chromatography data via the communication interface. For example, the method may comprise reading the raw chromatography data provided by the chromatography device or another data source. The method may comprise at least one data preparation step for preparing the raw chromatography data for model input. The data preparation step may comprise applying at least one data pre-processing step to the raw chromatography data. The pre-processing step may comprise one or more of smoothing and/or basic data transformation such as normalization, standardization, log transformation and the like.

The model input chromatography data may comprise at least one feature. The method may comprise at least one feature extraction or deriving step. The feature extraction or deriving step may comprise extracting or deriving the at least one feature from the preprocessed raw chromatography data for model input. The feature extraction or deriving step may comprise generating features for model input such as by determining derivatives, label encoding and the like. As will be outlined in more detail below, the machine learning model comprises at least one neural network, e.g at least one convolutional neural network (CNN). In case of a CNN, the feature generation based on an input may also be a learning objective of the model. For example, a convolutional layer in the neural network may receive a set of values as an input, apply a filter function and output a derived value which is used as an input in the next layer of the neural network. The filter function may be the determination of a linear trend in the set of input values. However, the parameters of the filter (and thus its specific function) are generally learned by the CNN. Usually a CNN comprises not only one filter function but several so that different features can be derived from the input.

The method may comprise determining if the received model input chromatography data comprises outlier. For example, the model input chromatography data may pressure data at at least one injection. The outlier detection may comprise determining if a development of pressure comprises at least one data point, which differs significantly, e.g. more than 10%, from other observations. For example, the outlier detection comprises determining deviations from and/or anomalies of a pressure curve, also denoted as abnormal behavior of the pressure curve. The outlier may be caused by distortions that are not associated with column aging, e.g. by capillary damage. The outlier detection may comprise using at least one trained data driven model. The trained data driven model may use a probabilistic supervised machine learning framework designed for regression and classification tasks. For example, the trained data driven model may be a Gaussian regression model. The data driven model may be designed for outlier detection using at least one Gaussian regression feature. For example, the outlier may be hidden in raw pressure curves but may become visible in scaled pressure curves pressure curves and may be detectable through at least one Gaussian regression feature. Different scaling methods may be possible such as standardization, min/max scaling. The Gaussian regression feature may be able to capture abnormal behavior in the pressure curves. Thereby the method may allow simple outlier detection in the column aging signals. The Gaussian regression feature can be used to track local changes in the data, e.g. abnormal behavior at the beginning of each injection, and may allow a better error analysis. The outlier detection can be implemented almost completely data-driven and does not impose restrictive conditions on the data. This may allow using automatic feature generation for continuous system monitoring of other parts of the chromatography device. In case an outlier is detected, the method may comprise removing and/or imputing the outlier. For example, the method may comprise flagging outliers when the used Gaussian regression features exceed at least one threshold. Known methods, e.g. as described in U.S. Pat. No. 5,670,379 A, fail to describe outlier removal. Alternatively, other outlier procedures where appropriate might be implemented. An outlier procedure may calculate one or more distance measures of a possible outlier relative to remaining normal observations or scores deviations from an assumed distribution of normal observations. For example, a large deviation of an observation from trend smoother (like loess) in conjunction with a threshold may be considered as an outlier. At least one clustering algorithm and/or at least one dimensionality reduction procedure (like principal component analysis or autoencoders) may be applied. An identified outlier may either be removed from the analysis or may be imputed by a smoothed value.

Step ii) may comprise feeding the model input chromatography data into the data driven model and computing a lifetime prediction. As used herein, the term “prediction” refers to expected value of the state variable in the future. A result of the determination in step ii) may be a predicted time series of the state variable such as one or more of a histogram, a point estimate such as mean, median and/or an uncertainty range, e.g. a confidence interval, showing a development of the state variable in time.

As used herein, the term “state variable indicative of lifetime of the chromatography column” is a broad term and is to be given its ordinary and customary meaning to a person of ordinary skill in the art and is not to be limited to a special or customized meaning. The term specifically may refer, without limitation, to an arbitrary characterizing lifetime of the chromatography column and/or allowing to draw conclusions about the lifetime of the chromatography column. For example, the state variable is at least one variable selected from the group consisting of: maximum pressure, peak width, retention time, peak symmetry.

The term “data driven model” as used herein is a broad term and is to be given its ordinary and customary meaning to a person of ordinary skill in the art and is not to be limited to a special or customized meaning. The term specifically may refer, without limitation, to an empirical, predictive model. The data driven model may comprise one or more of: at least one linear model; at least one non-linear model; at least one machine learning model. The machine learning model comprises at least one neural network. For example, the data driven model may be a physical model, e.g. based on and/or using differential equations for determining aging. For example, the machine learning model may comprise at least one recurrent neural network such as at least one long-short-term-memory (LSTM), at least one gated recurrent units (GRU), and/or at least one convolutional neural network (CNN) such as at least one long-term recurrent convolutional Network (LRCN); at least one fractional polynomial model. The data driven model may comprise at least one time series model such as Holt-Winters triple exponential smoothing, AutoRegressive-Integrated Moving Average (ARIMA). The data driven model may be a feature based model, wherein the features or a subset of features are used to predict lifetime. The training data may be used to select the features for the trained model. The feature selection may comprise selecting a subset of relevant features, in particular variables and predictors, for use in the construction of the model. Methods for interpretation of artificial intelligence models are known by the skilled person.

The data driven model may be derived from analysis of experimental data. The data driven model may comprise at least one trained model. The term “trained model” as used herein is a broad term and is to be given its ordinary and customary meaning to a person of ordinary skill in the art and is not to be limited to a special or customized meaning. The term specifically may refer, without limitation, to a model for predicting lifetime which was trained on at least one training dataset, also denoted training data. For example, the data driven model was trained on at least one training dataset. The training dataset may comprise historical data of at least one known chromatography column configuration. The historical data may comprise at least one feature, specifically a plurality of features derived from input variables such as standard deviation, mean absolute deviation, median, quantiles and the like, and/or from metadata. For example, the historical data comprises operating data of one or more of: pressure curve, maximum pressure, pressure difference at start and end of a chromatogram, peak width, retention time, peak symmetry. The method may comprise generating the at least one training data set and determining parameters of the data driven model by training the data driven model with the training data. For example for training, available historic data may be subdivided into data which is used for parameter determination, i.e. denoted as training data set, test dataset and validation dataset. The validation dataset may be a dataset used to tune hyperparameters. The test dataset may comprise historic data independent of the training dataset. The test dataset may be used for testing the model which was trained on the training data set. Such procedures are generally known to the skilled person. The parameters of the model may be determined using at least one optimization algorithm. The data driven model may be a self-learning model. The method may comprise updating the data driven model considering the received model input chromatography data and the determined state variable. The training of the model may comprise continuous training, for example using incoming data for further optimizing the model.

For example, the training data may be generated “stressing” a chromatography column with a defined matrix until it needs to be exchanged and a defined set of analytes is used to measure the performance. Such tests can be performed in an accelerated fashion where injections may be done with one or more of high frequency (no idle cycles) or concentrated matrix, e.g. having a higher load of aging related substances as normally expected, or in normal operation mode. Typically the matrix used is not random but one defined standard matrix that has been prepared in large quantities. The matrix may resemble closely what is expected in the real-world. For example, training data from customer laboratories may be used. This may ensure 100% realistic but may be problematic to have during development. Additionally or alternatively, mixed training data sets may be used comprising data sets of both examples.

For example, the data driven model is a linear model. For example, the state variable is pressure at injection, wherein the probability of the predicted value of the linear model being above a pre-specified limit is given by

$$p = 1 - cdf ( ( - mean + limit ) * sqrt ( ws ) / std ) ,$$

with “p” denoting the probability that the pressure is above the pre-specified limit, “mean” is the pressure predicted by the linear model, “limit” is the pre-specified limit, cdf is a cumulative density function, “sqrt( )” is the square root, ws is a window size (a number of data points used for determining of the “mean”), and “std” is the standard deviation in the sample.

For example, as an alternative to the linear model or in addition, a more complex model may be used such as a neural network. For example, the neural network may be a RNN. The RNNs may be designed for receiving multiple input features simultaneously to calculate a pressure prediction, also denoted as pressure forecast. This may allow increasing the model performance significantly. For example, the state variable is pressure at injection and as model input chromatography data retention time, pressure maximum, pressure difference at start and end of a chromatogram may be used.

For example, the data driven model may comprise at least two Long short-term memory (LSTM) layers. The data driven model may comprise a single output node. For example, each of the LSTM layers may be designed with 25 hidden units. The window size may be fixed to 20 input values and a varying number of input features. For example, training was done using an adam optimization algorithm, a batch size of 32 samples and total number of 100 epochs. Five training columns with a total number of 2305 samples were used as a training set.

For example, the data driven model may comprise at least two LSTM layers. A first LSTM layer may be used as encoder layer and a second LSTM layer may be used as decoder layer. The first LSTM layer, e.g. designed with 25 hidden units, may be used as an encoder of the input window. The data driven model may further comprise at least one attention layer, wherein the attention layer may be designed for weighing hidden states in the encoder layer. The output of this layer may be fed into the second LSTM layer which serves as a decoder and outputs a sequence of time steps, e.g. of 50 time steps. The window size may be fixed to 20 input values and a varying number of input features. For example, training was done using an adam optimization algorithm, a batch size of 32 samples and total number of 100 epochs. Five training columns with a total number of 2305 samples were used as a training set.

For example, the data driven model may be a fractional polynomial model. The state variable is pressure at injection and as model input chromatography data retention time, pressure maximum, pressure difference at start and end of a chromatogram are used. For example, the fractional polynomial model is given by

$$Y ( t ) = {β}_{0} + {{β}_{1} ( \frac{t}{1000} )}^{a} + {{β}_{2} ( \frac{t}{1000} )}^{b} \times log ( \frac{t}{1000} ) + ε ( t )$$

with Y(t) denoting the pressure at injection t and β0, β1, and β2 as regression coefficients, a and b are fit results and c (t) as residual. For example, a and b may be 4.5. For example, a range of values for a and b may be from −10 to 10, for example from −4 to 6, without 0. Chromatography columns may exhibit non-linear behavior in degradation over time. Fractional polynomials may have flexibility of modelling a wide variety of non-linear behavior. Fractional polynomials can deliver good models accounting for monotonic increasing trend. It was found that fractional polynomial models can give reasonable predictions of RUL, for example predictions were found to be within +/−10% deviation from true lifetime.

Usually, the skilled person uses simple Taylor series, e.g. as described in U.S. Pat. No. 5,670,379 A. In contrast thereto, the present invention proposes using one or more of the above-mentioned models.

Step iii) comprises evaluating the determined state variable thereby determining information about lifetime by using the processing device. In case step ii) comprises determining a plurality of state variables, step iii) may comprise evaluating a set of state variables. For example, pressure and retention time may be used, e.g. with individual thresholds. The term “evaluating” as used herein is a broad term and is to be given its ordinary and customary meaning to a person of ordinary skill in the art and is not to be limited to a special or customized meaning. The term specifically may refer, without limitation, to applying at least one mathematical operation to the determined state variable, e.g. at least one comparison. The evaluation comprises comparing the determined state variable to at least one threshold. The term “threshold” as used herein is a broad term and is to be given its ordinary and customary meaning to a person of ordinary skill in the art and is not to be limited to a special or customized meaning. The term specifically may refer, without limitation, to at least one pre-defined value or at least one pre-defined range of the state variable assumed to relate to a lifetime value ensuring that the chromatography column is still suitable for a given assay. The threshold may be selected in order to ensure the chromatography column fulfilling at least one applicable quality criteria. For example, for pressure a pressure maximum of the HPLC pump may be used, such as with an additional safety margin. The threshold may be depend on a manufacturer of the pump. For example, for Agilent© Infinity II the threshold may be about 1000 bar. For example, the threshold may be for retention time ±2.5%. For example, for the FWHM at least one derived quality criterion may be used such as resolution: ≥1.25 and/or tailing factor: <2. For example, for the FWHM at least one percentage deviation from a target value may be used such as ±2%. For example, step iii) may comprise comparing the prediction determined in step ii) to at least one threshold and computing a probability of failure of the chromatography column. For example, the information about lifetime may comprise one or more of probability of failure, pressure at future time points, remaining useful lifetime, remaining useful counts, a binary information such as change column or keep column and the like. The information about lifetime may comprise at least one output recommendation for the chromatography column.

The method may further comprise step iv) providing information about lifetime via at least one user interface and/or initializing at least one maintenance process in case it is determined in step iii) that the value of the state variable exceeds the threshold. The term “user interface” as used herein is a broad term and is to be given its ordinary and customary meaning to a person of ordinary skill in the art and is not to be limited to a special or customized meaning. The term may refer, without limitation, to an element or device which is configured for interacting with its environment, such as for the purpose of unidirectionally or bidirectionally exchanging information, such as for exchange of one or more of data or commands. For example, the user interface may be configured to share information with a user and to receive information by the user. The user interface may be a feature to interact visually with a user, such as a display, or a feature to interact acoustically with the user. The user interface, as an example, may comprise one or more of: a graphical user interface; a data interface, such as a wireless and/or a wire-bound data interface. The initializing of the at least one maintenance process may comprise initializing at least one action for handling the chromatography column and/or for handling a sample to be analyzed. For example, the action may comprise rerouting a sample in a multi-stream LC/MS to an alternative stream.

For example, the user interface may comprise at least one graphical user interface (GUI) configured for displaying the information about lifetime. For example, GUI may display instructions to manually exchange the chromatography column. The user follows the instructions on GUI to manually exchange the chromatography column. The LC system automatically may prepare the chromatography column, e.g. by an equilibration cycle with appropriate eluents, and gets back to operation.

The proposed method may allow reducing costs. Prediction of chromatography column end of life may ensure the most efficient use of chromatography columns thereby reducing assay costs without sacrificing performance. The proposed method may allow optimized through-put. System down-time may be minimized by warning the operator ahead of time allowing scheduled maintenance. The proposed method may allow increasing reliability. Performance prediction allows rerouting of samples in a multi-stream LC/MS thereby avoiding measurement on erroneous columns thereby avoiding sample loss. The proposed method may allow increasing performance. The proposed method may allow determining lifetime over many hours with a relative accuracy as low as 5-10%. The proposed data driven prediction may take individual laboratory and column production factors into account and may be superior to classical statistical approaches. The proposed method may allow increasing patient safety. Performance prediction can be automatized on a fully automated MS based analyzers and thus, critical measurement errors can be avoided in the IVD environment.

In a further aspect, a test system configured for performing the method for determining lifetime according to the present invention is proposed. The term “system” as used herein is a broad term and is to be given its ordinary and customary meaning to a person of ordinary skill in the art and is not to be limited to a special or customized meaning. The term specifically may refer, without limitation, to an arbitrary set of interacting or interdependent components parts forming a whole. Specifically, the components may interact with each other in order to fulfill at least one common function. The at least two components may be handled independently or may be coupled or connectable.

The test system comprises
at least one communication interface configured for receiving model input chromatography data,
at least one processing device configured for determining at least one state variable indicative of lifetime of the chromatography column using at least one data driven model based on the model input chromatography data, wherein the processing device is configured for evaluating the determined state variable thereby determining information about lifetime, wherein the evaluating comprises comparing the determined state variable to at least one threshold;
at least one user interface configured for providing the information about lifetime and/or initializing at least one maintenance process.

With respect to embodiments and definitions of the test system reference is made to embodiments and definitions of the method for determining lifetime as given above or in more detail below.

In a further aspect a computer program for determining lifetime of at least one chromatography column of at least one chromatography device, configured for causing a computer or computer network to perform the method for determining lifetime of at least one chromatography column of at least one chromatography device according to the present invention, when executed on the computer or computer network, wherein the computer program is configured to perform at least steps i) to iii), and optionally step iv), of the method for determining lifetime. Specifically, the computer program may be stored on a computer-readable data carrier and/or on a computer-readable storage medium.

As used herein, the terms “computer-readable data carrier” and “computer-readable storage medium” specifically may refer to non-transitory data storage means, such as a hardware storage medium having stored thereon computer-executable instructions. The computer-readable data carrier or storage medium specifically may be or may comprise a storage medium such as a random-access memory (RAM) and/or a read-only memory (ROM).

Thus, specifically, one, more than one or even all of method steps i) to iii), and optionally step iv), as indicated above may be performed by using a computer or a computer network, preferably by using a computer program.

Further disclosed and proposed herein is a computer program product having program code means, in order to perform the method according to the present invention in one or more of the embodiments enclosed herein when the program is executed on a computer or computer network. Specifically, the program code means may be stored on a computer-readable data carrier and/or on a computer-readable storage medium.

Further disclosed and proposed herein is a data carrier having a data structure stored thereon, which, after loading into a computer or computer network, such as into a working memory or main memory of the computer or computer network, may execute the method according to one or more of the embodiments disclosed herein.

Further disclosed and proposed herein is a computer program product with program code means stored on a machine-readable carrier, in order to perform the method according to one or more of the embodiments disclosed herein, when the program is executed on a computer or computer network. As used herein, a computer program product refers to the program as a tradable product. The product may generally exist in an arbitrary format, such as in a paper format, or on a computer-readable data carrier and/or on a computer-readable storage medium. Specifically, the computer program product may be distributed over a data network. Finally, disclosed and proposed herein is a modulated data signal which contains instructions readable by a computer system or computer network, for performing the method according to one or more of the embodiments disclosed herein.

Referring to the computer-implemented aspects of the invention, one or more of the method steps or even all of the method steps of the method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

Specifically, further disclosed herein are:
a computer or computer network comprising at least one processor, wherein the processor is adapted to perform the method according to one of the embodiments described in this description,
a computer loadable data structure that is adapted to perform the method according to one of the embodiments described in this description while the data structure is being executed on a computer,
a computer program, wherein the computer program is adapted to perform the method according to one of the embodiments described in this description while the program is being executed on a computer,
a computer program comprising program means for performing the method according to one of the embodiments described in this description while the computer program is being executed on a computer or on a computer network,
a computer program comprising program means according to the preceding embodiment, wherein the program means are stored on a storage medium readable to a computer,
a storage medium, wherein a data structure is stored on the storage medium and wherein the data structure is adapted to perform the method according to one of the embodiments described in this description after having been loaded into a main and/or working storage of a computer or of a computer network, and
a computer program product having program code means, wherein the program code means can be stored or are stored on a storage medium, for performing the method according to one of the embodiments described in this description, if the program code means are executed on a computer or on a computer network.

In a further aspect, a method for operating a chromatography column is proposed. The method comprises the following steps which, as an example, may be performed in the given order. It shall be noted, however, that a different order is also possible. Further, it is also possible to perform one or more of the method steps once or repeatedly. Further, it is possible to perform two or more of the method steps simultaneously or in a timely overlapping fashion. The method may comprise further method steps which are not listed.

The method comprises the following steps:
(a) performing a multitude of chromatographic separations of samples on said chromatography column;
(b) providing model input chromatography data for at least a fraction of said chromatographic separations; and
(c) determining lifetime of said chromatography column according to the method for determining lifetime according to the present invention.

For example, step a) may comprise applying a sample and at least one column void volume, in a further example at least one column volume, of mobile phase onto said chromatography column. The step may further comprise applying further mobile phase, a mobile phase gradient and/or applying steps of re-equilibration to the chromatography column. Also, the step may include detection of one or more analyte(s) after separation by means known to the skilled person, and/or collection of one or more fraction(s) for further analysis. The step may also comprise performing mass spectrometry on at least part of the eluate from the chromatography column.

Use of said chromatography column may be discontinued or modified in case said lifetime exceeds a threshold, e.g. in case the determined lifetime is outside a pre-defined reference range or is beyond a threshold.

Summarizing and without excluding further possible embodiments, the following embodiments may be envisaged:
Embodiment 1. A computer implemented method for determining lifetime of at least one chromatography column of at least one chromatography device, wherein the method comprises the following steps:
   i) receiving model input chromatography data via at least one communication interface;
   ii) determining at least one state variable indicative of lifetime of the chromatography column using at least one data driven model based on the model input chromatography data using at least one processing device;
   iii) evaluating the determined state variable thereby determining information about lifetime by using the processing device, wherein the evaluation comprises comparing the determined state variable to at least one threshold.
Embodiment 2. The method according to the preceding embodiment, wherein determining a lifetime comprises predicting lifetime over subsequent chromatographic separations such as over the next 5, preferably the next 10, more preferably the next 35, chromatographic separations.
Embodiment 3. The method according to any one of the preceding embodiments, wherein the model input chromatography data comprises at least one input parameter selected from the group consisting of: maximum pressure, pressure difference at start and end of a chromatogram, peak width, retention time, peak symmetry, sample type, assay type of each measurement, usage time of the chromatography column on the chromatography device, at least one maintenance parameter, change of chromatography column.
Embodiment 4. The method according to any one of the preceding embodiments, wherein the model input chromatography data comprises metadata relating to one or more of at least one chromatography column production factor, at least one laboratory specific factor.
Embodiment 5. The method according to any one of the preceding embodiments, wherein the state variable is at least one variable selected from the group consisting of: maximum pressure, pressure difference at start and end of a chromatogram, peak width, retention time, peak symmetry.
Embodiment 6. The method according to any one of the preceding embodiments, wherein the data driven model comprises one or more of: at least one linear model; at least one non-linear model; at least one machine learning model; at least one time series model, wherein the machine learning model comprises at least one recurrent neural network such as at least one long-short-term-memory (LSTM), at least one gated recurrent units (GRU), and/or at least one convolutional neural network (CNN) such as at least one long-term recurrent convolutional Network (LRCN); at least one fractional polynomial model.
Embodiment 7. The method according to embodiment 6, wherein the data driven model is a linear model, wherein the probability of the predicted value of the state variable being above a pre-specified limit is given by

$$p = 1 - cdf ( ( - mean + limit ) * sqrt ( ws ) / std ) ,$$

with “p” denoting the probability that the pressure is above the pre-specified limit, “mean” is the pressure predicted by the linear model, “limit” is the pre-specified limit, cdf is a cumulative density function, “sqrt( )” is the square root, ws is a window size, and “std” is the standard deviation in the sample.
Embodiment 8. The method according to embodiment 6, wherein the data driven model is a recurrent neural network, wherein the state variable is pressure at injection and as model input chromatography data retention time, pressure maximum, pressure difference at start and end of a chromatogram are used, wherein the data driven model comprises at least two Long short-term memory (LSTM) layers, wherein a first LSTM layer is used as encoder layer and a second LSTM layer is used as decoder layer, wherein the data driven model further comprises at least one attention layer, wherein the attention layer is designed for weighing hidden states in the first LSTM layer, wherein an output of the attention layer is fed into the second LSTM layer which outputs a sequence of time steps.
Embodiment 9. The method according to embodiment 6, wherein the data driven model is a fractional polynomial model, wherein the state variable is pressure at injection and as model input chromatography data retention time, pressure maximum, pressure difference at start and end of a chromatogram are used, wherein the fractional polynomial model is given by

$$Y ( t ) = {β}_{0} + {{β}_{1} ( \frac{t}{1000} )}^{a} + {{β}_{2} ( \frac{t}{1000} )}^{b} \times log ( \frac{t}{1000} ) + ε ( t )$$

with Y(t) denoting the pressure at injection t and β₀, β₁, and β₂ as regression coefficients, a and b are fit results and ¿ (t) as residual.
Embodiment 10. The method according to any one of the preceding embodiments, wherein the data driven model was trained on at least one training dataset, wherein the training dataset comprises historical data of at least one known chromatography column configuration, wherein the historical data comprises operating data of one or more of: pressure curve, maximum pressure, pressure difference at start and end of a chromatogram, peak width, retention time, peak symmetry.
Embodiment 11. The method according to the preceding embodiment, wherein the method comprises generating the at least one training data set and determining parameters of the data driven model by training the data driven model with the training data, wherein the parameters are determined using at least one optimization algorithm.
Embodiment 12. The method according to any one of the preceding embodiments, wherein the data driven model is a self-learning model, wherein the method comprises updating the data driven model considering the received model input chromatography data and the determined state variable.
Embodiment 13. The method according to any one of the preceding embodiments, wherein the information about lifetime comprises one or more of probability of failure, pressure at future time points, remaining useful lifetime.
Embodiment 14. The method according to any one of the preceding embodiments, wherein the information about lifetime comprises at least one output recommendation for the chromatography column.
Embodiment 15. The method according to any one of the preceding embodiments, further comprising step iv) providing information about lifetime via at least one user interface and/or initializing at least one maintenance process in case it is determined in step iii) that the value of the state variable exceeds the threshold.
Embodiment 16. The method according to the preceding embodiment, wherein the initializing of the at least one maintenance process comprises initializing at least one action for handling the chromatography column and/or for handling a sample to be analyzed.
Embodiment 17. The method according to any one of the two preceding embodiments, wherein the user interface comprises at least one graphical user interface (GUI) configured for displaying the information about lifetime.
Embodiment 18. The method according to any one of the preceding embodiments, wherein the method comprises receiving raw chromatography data via the communication interface, wherein the method comprises at least one data preparation step for preparing the raw chromatography data for model input, wherein the data preparation step comprises applying at least one data pre-processing step to the raw chromatography data, wherein the pre-processing step comprises one or more of smoothing, basic data transformation.
Embodiment 19. The method according to the preceding embodiment, wherein the model input chromatography data comprises at least one feature, wherein the method comprises at least one feature extraction or deriving step, wherein the feature extraction or deriving step comprises extracting or deriving the at least one feature from the preprocessed raw chromatography data for model input.
Embodiment 20. A test system configured for performing the method according to any one of the preceding embodiments, wherein the test system comprises
   at least one communication interface configured for receiving model input chromatography data,
   at least one processing device configured for determining at least one state variable indicative of lifetime of the chromatography column using at least one data driven model based on the model input chromatography data, wherein the processing device is configured for evaluating the determined state variable thereby determining information about lifetime, wherein the evaluating comprises comparing the determined state variable to at least one threshold;
   at least one user interface configured for providing the information about lifetime and/or initializing at least one maintenance process.
Embodiment 21. Computer program for determining lifetime of at least one chromatography column of at least one chromatography device, configured for causing a computer or computer network to perform the method for determining lifetime of at least one chromatography column of at least one chromatography device according to any one of the preceding embodiments referring to a method for determining lifetime of at least one chromatography column, when executed on the computer or computer network, wherein the computer program is configured to perform at least steps i) to iii), and optionally iv) of the method for determining lifetime of at least one chromatography column of at least one chromatography device according to any one of the preceding embodiments referring to a method for determining lifetime of at least one chromatography column.
Embodiment 22. A method for operating a chromatography column comprising
   (a) performing a multitude of chromatographic separations of samples on said chromatography column;
   (b) providing model input chromatography data for at least a fraction of said chromatographic separations; and
   (c) determining lifetime of said chromatography column according to the method of any one of embodiments 1 to 19.
Embodiment 23. The method of embodiment 21, wherein use of said chromatography column is discontinued or modified in case said lifetime exceeds a threshold.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIG. 1 shows exemplary embodiments of a chromatography device and of a test system in a schematic view;

FIG. 2 shows a diagram of exemplary maximum pressure values derived from a multitude of chromatographic separations;

FIGS. 3 to 5 show flow charts of exemplary embodiments of a computer implemented method for determining lifetime of at least one chromatography column of at least one chromatography device;

FIGS. 6A to 6F show diagrams of exemplary results of a method for determining lifetime with a data driven model comprising a linear model;

FIGS. 7A to 7C show diagrams of relative errors on the results of FIGS. 6A to 6F;

FIGS. 8A to 8H show diagrams of exemplary results of a method for determining lifetime with a data driven model comprising a first machine learning model;

FIGS. 9A to 9D show diagrams of exemplary results of a method for determining lifetime with a data driven model comprising a second machine learning model;

FIGS. 10A to 10F shows diagrams of exemplary results on information about lifetime of a chromatography column obtained by performing a method for determining lifetime;

FIG. 11 shows a flow chart of an exemplary embodiment of a method for operating a chromatography column;

FIGS. 12A to 12C show experimental results.

### DETAILED DESCRIPTION OF THE EMBODIMENTS

FIG. 1 shows exemplary embodiments of a chromatography device 110 and of a test system 112 in a schematic view. The chromatography device 110, for example, may comprise at least one liquid chromatography device 114. The liquid chromatography device 114 may be or may comprise at least one high-performance liquid chromatography (HPLC) device or at least one micro liquid chromatography (μLC) device. The chromatography device 110 may comprise at least one chromatography column 116. In the example shown in FIG. 1, the chromatography device 110 may be a single-column device. However, other embodiments such as a multi-column device having a plurality of columns 116 are also feasible. The chromatography column 116 may have a stationary phase through which a mobile phase is pumped in order to separate and/or elute and/or transfer analytes of interest.

In the example of FIG. 1, the chromatography column 116 may comprise at least one interface 118 for introducing the mobile phase into the stationary phase. The interface 118 for introducing the mobile phase may comprise one or more of pumps, solvent reservoirs, mixing vessels, valves and/or the like.

The chromatography device 110 may be coupled, for example via at least one interface 120, to a mass spectrometry device 122. The mass spectrometry device 122 may be or may comprise at least one quadrupole mass spectrometry device 124. The interface 120 coupling the chromatography device 110 and the mass spectrometry device 122 may comprise at least one ionization source 126 configured for generating of molecular ions and for transferring of the molecular ions into the gas phase.

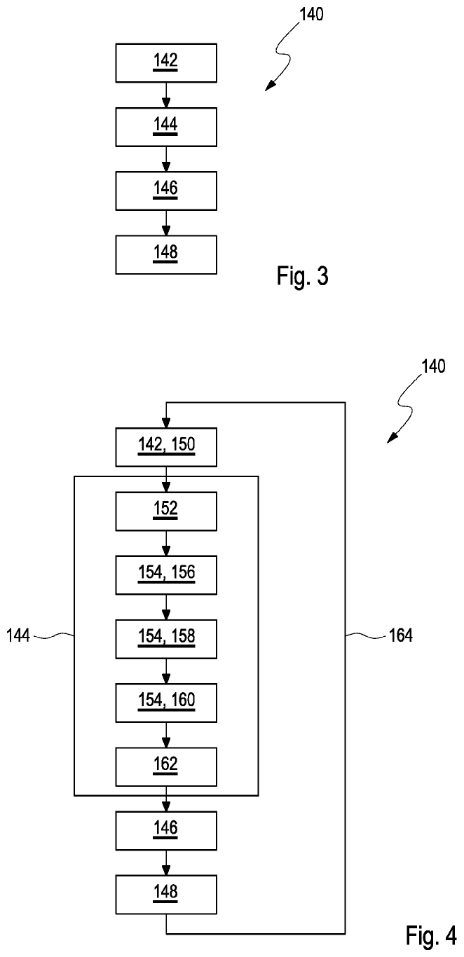

The chromatography device 110 may be connected, in particular via at least one communication interface 128, to the test system 112, specifically for transferring chromatography data. The test system 112 is configured for performing a method 140 for determining lifetime according to the present invention, such as according to any one of the embodiments disclosed above and/or any one of the embodiments disclosed in further detail below. Exemplary embodiments of the method 140 are shown in FIGS. 3 to 5.

The test system 112 comprises:
the at least one communication interface 128 configured for receiving model input chromatography data,
at least one processing device 130 configured for determining at least one state variable indicative of lifetime of the chromatography column 116 using at least one data driven model based on the model input chromatography data, wherein the processing device 130 is configured for evaluating the determined state variable thereby determining information about lifetime, wherein the evaluating comprises comparing the determined state variable to at least one threshold;
at least one user interface 132 configured for providing the information about lifetime and/or initializing at least one maintenance process.

The user interface 132, as an example, may comprise at least one graphical user interface (GUI) configured for displaying the information about lifetime. For example, GUI may display instructions to manually exchange the chromatography column 116. The user follows the instructions on GUI to manually exchange the chromatography column 116. The LC system automatically may prepare the chromatography column 116, e.g. by an equilibration cycle with appropriate eluents, and gets back to operation.

As shown in FIG. 1, the communication interface 128, the processing device 130 and the user interface 132 of the test system 112 may be connected with each other, specifically for a purpose of unidirectional or bidirectional data exchange.

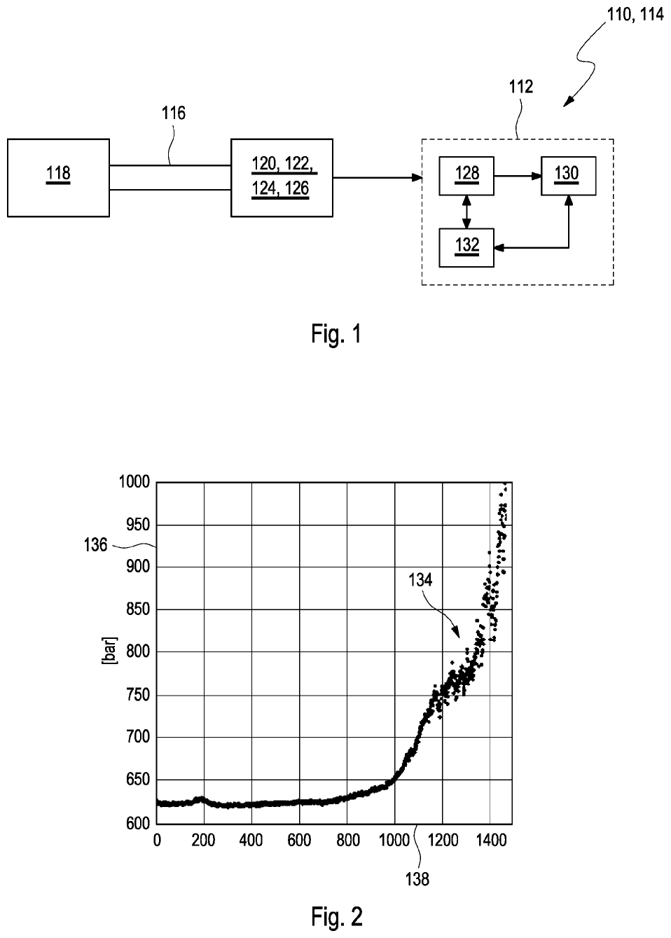

In FIG. 2, a diagram of exemplary chromatography data 134, in particular maximum pressure values derived from a multitude of chromatographic separations, is shown. In this example, the chromatography data 134 may comprise as an input parameter pressure at injection 136. The pressure at injection 136 may be equivalent to a maximum pressure in the chromatography column 116. Thus, the pressure at injection 136 may be used equivalently for the maximum pressure in the chromatography column 116 as in input parameter. The pressure at injection 136 is shown in the diagram of FIG. 2 as a function of a number of injections 138. The chromatography data 134 may specifically be used as input data for the data driven model, thus, rendering the chromatography data 134 model input chromatography data, as will be outlined in further detail below. As can be seen in FIG. 2, the pressure at injection 136 raises with higher numbers of injections 138. Generally, pressure rise may be a common effect in chromatography column aging. Thus, pressure at injection 136 may provide a good basis for the state variable being indicative of lifetime of the chromatography column 116.

However, other options for the model input chromatography data are also feasible, such as model input chromatography data comprising at least one input parameter selected from the group consisting of: maximum pressure, pressure difference at start and end of a chromatogram, peak width, retention time, peak symmetry, sample type, assay type of each measurement, usage time of the chromatography column 116 on the chromatography device 110, at least one maintenance parameter e.g. relating to column care, change of chromatography column 116.

FIG. 3 shows a flow chart of an exemplary embodiment of a computer implemented method 140 for determining lifetime of the at least one chromatography column 116 of the at least one chromatography device 110. The method 140 comprises the following steps which, as an example, may be performed in the given order. It shall be noted, however, that a different order is also possible. Further, it is also possible to perform one or more of the method steps once or repeatedly. Further, it is possible to perform two or more of the method steps simultaneously or in a timely overlapping fashion. The method 140 may comprise further method steps which are not listed.

The method 140 comprises the following steps:
i) (denoted by reference number 142) receiving model input chromatography data via the at least one communication interface 128;
ii) (denoted by reference number 144) determining at least one state variable indicative of lifetime of the chromatography column 116 using at least one data driven model based on the model input chromatography data using at least one processing device 130;
iii) (denoted by reference number 146) evaluating the determined state variable thereby determining information about lifetime by using the processing device 130, wherein the evaluation comprises comparing the determined state variable to at least one threshold.

The determining a lifetime may comprise predicting lifetime over subsequent chromatographic separations such as over the next 5, preferably the next 10, more preferably the next 35, chromatographic separations. For example, 35, 65, 130, 265 chromatographic separations may relate to 1 h, 2 h, 4 h and 8 h. For example, the determining a lifetime may comprise predicting lifetime over the next 35 chromatographic separations. This may allow having time for reacting depending on the result of the lifetime determination. However, the number of chromatographic separations may relate to a system design and, in particular, may depend on the number of streams. For a three stream system, 35 injections may be used. For six streams, for example, 17 injections may be used.

The method 140 may further comprise step iv) (denoted by reference number 148) providing information about lifetime via the at least one user interface 132 and/or initializing at least one maintenance process in case it is determined in step iii) that the value of the state variable exceeds the threshold. The initializing of the at least one maintenance process may comprise initializing at least one action for handling the chromatography column 116 and/or for handling a sample to be analyzed. For example, the action may comprise rerouting a sample in a multi-stream LC/MS to an alternative stream.

The information about lifetime may comprise one or more of probability of failure, pressure at future time points, remaining useful lifetime, remaining useful counts, a binary information such as change column or keep column and the like. The information about lifetime may comprise at least one output recommendation for the chromatography column 116.

The data driven model in step ii) of the method 140 may comprise one or more of: at least one linear model; at least one non-linear model; at least one machine learning model; at least one time series model. FIG. 4 shows an exemplary embodiment of the computer implemented method 140 for determining lifetime of the at least one chromatography column 116 of the at least one chromatography device 110, wherein in the example of FIG. 4, the data driven model comprises a linear model.

The method 140 may comprise receiving raw chromatography data 134 via the communication interface 128 (denoted by reference number 150). For example, the method 140 may comprise reading the raw chromatography data 134 provided by the chromatography device 110 or another data source. As shown in FIG. 4, the partial steps of receiving raw chromatography data 134 and reading the raw chromatography data 134 may form part of method step i) (denoted by reference number 142).

Further, in the example shown in FIG. 4, method step ii) (denoted by reference number 144) may comprise a plurality of different partial steps: The method 140 may comprise at least one data preparation step (denoted by reference number 152) for preparing the raw chromatography data 134 for model input. The data preparation step 152 may comprise applying at least one data pre-processing step to the raw chromatography data 134. The pre-processing step may comprise one or more of smoothing and/or basic data transformation such as normalization, standardization, log transformation and the like. For example, a Savitzky-Golay filter may be applied to the raw chromatography data 134.

The model input chromatography data may comprise at least one feature. The method 140 may comprise at least one feature extraction or deriving step (denoted by reference number 154). The feature extraction or deriving step 154 may comprise extracting or deriving the at least one feature from the preprocessed raw chromatography data 134 for model input. The feature extraction or deriving step 154 may comprise generating features for model input such as by determining derivatives, label encoding and the like. In the example of FIG. 4, the feature extraction or deriving step 154 may comprise one or more partial steps, specifically one or more of a partial step of determining a derivative (denoted by reference number 156), a partial step of determining a linear prediction (denoted by reference number 158) and a partial step of determining a “mean” and/or a standard deviation (denoted by reference number 160).

Further in the exemplary embodiment of FIG. 4, step ii) may comprise feeding the model input chromatography data into the data driven model and computing a lifetime prediction (denoted by reference number 162). A result of the determination in step ii) may be a predicted time series of the state variable such as one or more of a histogram, a point estimate such as mean, median and/or an uncertainty range, e.g. a confidence interval, showing a development of the state variable in time.

For example, the state variable is pressure at injection 136, wherein the probability of the predicted value of the linear model being above a pre-specified limit is given by

$$p = 1 - cdf ( ( - mean + limit ) * sqrt ( ws ) / std ) ,$$

with “p” denoting the probability that the pressure is above the pre-specified limit, “mean” is the pressure predicted by the linear model, “limit” is the pre-specified limit, cdf is a cumulative density function, “sqrt( )” is the square root, ws is a window size (a number of data points used for determining of the “mean”), and “std” is the standard deviation in the sample.

As outlined above, subsequent method step iii) (denoted by reference number 146) comprises evaluating the determined state variable and comparing the determined state variable to the at least one threshold. For example, step iii) may comprise comparing the prediction determined in step ii) to the at least one threshold and computing a probability of failure of the chromatography column 116. Step iv) (denoted by reference number 148) may comprise providing information about lifetime via the at least one user interface 132. As shown in FIG. 4 by arrow 164, the method 140 may be repeated beginning with step i), for example in case the prediction is below the threshold and/or the information about lifetime indicates the chromatography column 116 is still suitable for a given assay.

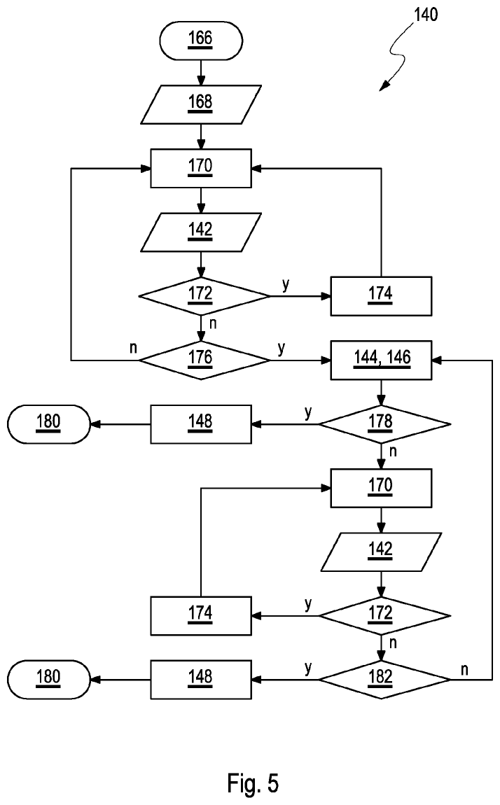

In FIG. 5, a flow chart of an alternative embodiment of the computer implemented method 140 for determining lifetime of the at least one chromatography column 116 of the at least one chromatography device 110 is shown. The method 140 may start at reference number 166. In the subsequent method step (denoted by reference number 168), a variable indicating the number of injections may be set to zero and metadata may be retrieved.

The model input chromatography data may comprise metadata relating to one or more of at least one chromatography column production factor, at least one laboratory specific factor. The metadata may relate to arbitrary data for a new chromatography column 116 provided by a manufacturer, e.g. via a barcode, RFID or other data carrier. For example, the metadata may comprise one or more of column dimensions, e.g. length, width, diameter such as inner and/or outer diameter, inner volume, inner surface, information about lot, manufacturer, installation time.

A subsequent method step (denoted by reference number 170) may comprise increasing the variable indicating the number of injections by a predefined increment, specifically by an increment of 1. The following step may comprise step i) (denoted by reference number 142), as outlined in further detail above. Method step i) may be followed by a decision node (denoted by reference number 172), wherein the decision node 172 comprises determining if the received model input chromatography data comprises an outlier. If so, the method 140 may proceed with method step 174, wherein method step 174 may comprise removing and/or imputing the outlier. If the model input chromatography data does not comprise an outlier, the method 140 may proceed with a further decision node 176. Known methods, e.g. as described in U.S. Pat. No. 5,670,379 A, fail to describe outlier removal. Decision node 176 may comprise determining if the model input chromatography data exceeds a threshold or elevation level. If the model input chromatography data is below the threshold or elevation level, the method 140 may return to method step 170. If the model input chromatography data is above the threshold or elevation level, the method 140 may continue with method step ii) (denoted by reference number 144) and method step iii) (denoted by reference number 146), as outlined in further detail above.

In the example of FIG. 5, the method 140 may comprise, subsequently to method steps ii) and iii), a decision node 178. At decision node 178, it may be determined if the determined state variable exceeds the threshold. If the determined state variable exceeds the threshold, the method 140 may continue with method step iv) (denoted by reference number 148), specifically indicating that a use of the chromatography column 116 has to be discontinued or modified. In this case, the method 140 may stop at reference number 180. If the determined state variable is below the threshold, the method 140 may proceed with method steps 170, 142, 172 and 174 as explained above. However, if, at decision node 172, it is determined that the model input chromatography data does not comprise an outlier, the method 140 may proceed with a further decision node 182. Decision node 182 may comprise determining if the variable indicating the number of injections exceed a predetermined threshold, for example a predetermined threshold of 5000 injections. If the variable indicating number of injections exceeds the predetermined threshold, the method 140 may continue with method step iv) (denoted by reference number 148), specifically indicating the end of lifetime of the chromatography column 116, and the method 140 may stop at reference sign 180. If the variable indicating number of injections is below the predetermined threshold, the method 140 may return to method step ii) (denoted by reference number 144) and method step iii) (denoted by reference number 146).

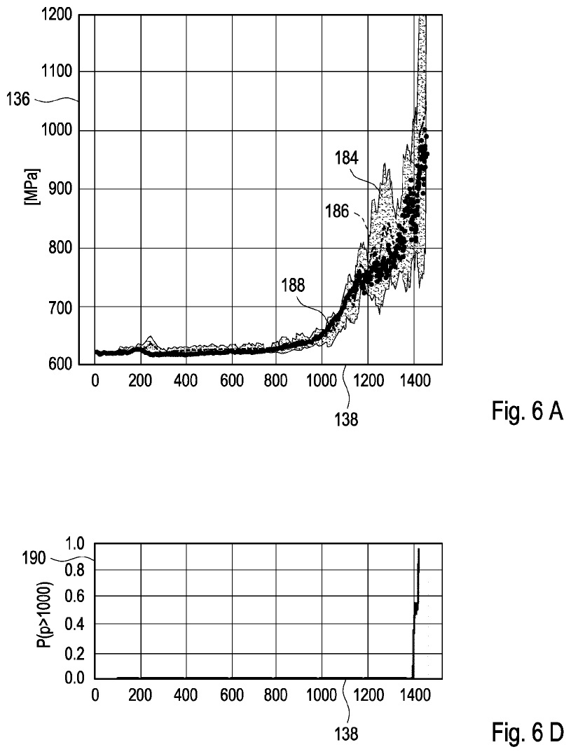

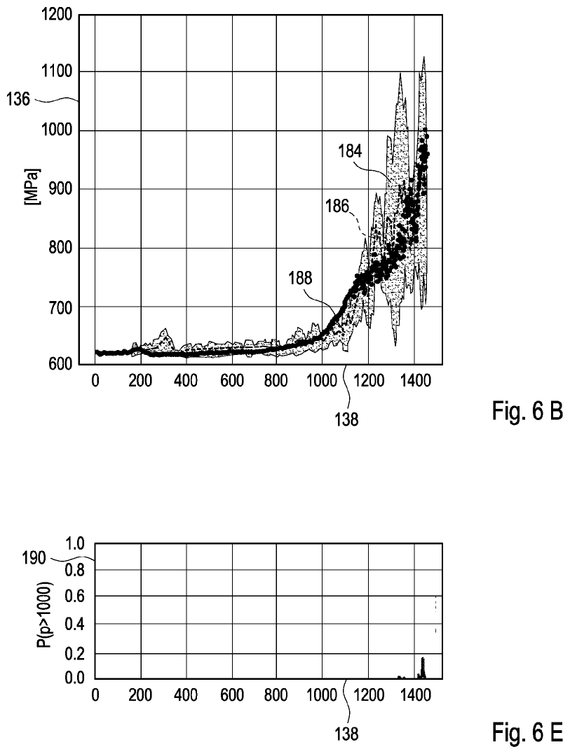

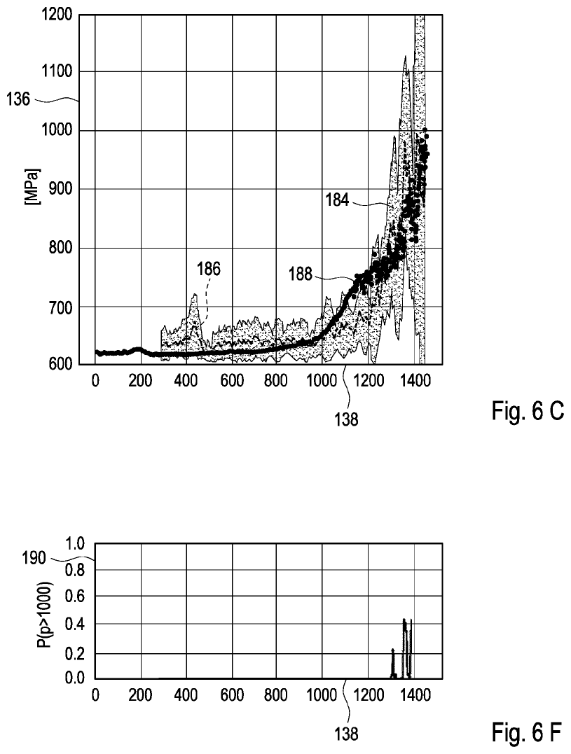

FIGS. 6A to 6F show diagrams of exemplary results of the method 140 for determining lifetime 140 with the data driven model comprising the linear model. The results of FIGS. 6A to 6F may be obtained when performing the method 140 according to the present invention, for example according the embodiment discussed with reference to FIG. 4. However, other embodiments, such as any one of the embodiments discussed referring to FIGS. 3 and 5, are also feasible. In the examples shown in FIGS. 6A to 6F, the state variable is pressure at injection 136. In FIGS. 6A to 6C, the pressure at injection 136 is shown as a function of the number of injections 138. Therein, predicted pressure at injection 184, mean of predicted pressure at injection 186 and observed pressure at injection 188 are shown in a combined diagram. In FIGS. 6D to 6F, the probability of failure 190 is shown as a function of the number of injections 138. Specifically, the probability of failure 190 may be determined according to above identified formula, as discussed with reference to FIG. 4. Further, in FIGS. 6A and 6D, a total number of 65 data points were used for determining the state variable, whereas in FIGS. 6B and 6E, a total number of 130 data points were used and in FIGS. 6C and 6F, a total number of 265 data points were used.

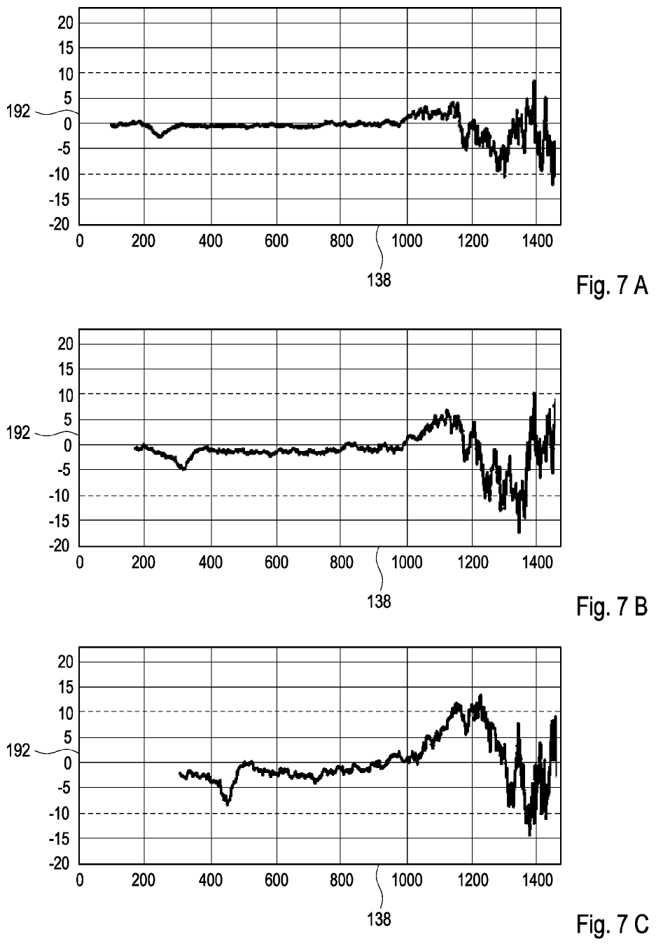

The quality of the prediction shown in FIGS. 6A to 6F may be assessed when referring to FIGS. 7A to 7C. In FIGS. 7A to 7C, diagrams of relative errors 192 on the results of FIGS. 6A to 6F are shown. Specifically, the relative error 192 may be obtained by comparing the mean of the predicted pressure 186 with the observed pressure 188 as a function of the number of injections 138. FIG. 7A shows the relative error 192 for the prediction of FIG. 6A, FIG. 7B shows the relative error 192 for the prediction of FIG. 6B and FIG. 7C shows the relative error 192 for the prediction of FIG. 6C. As indicated by the dashed lines 194 in FIGS. 7A to 7C, marking a relative error 192 of ±10%, a vast majority of the relative errors 192 may be in the range of ±10%. Only few relative errors 192 may exceed ±10% and, however, may still be less than ±15%.

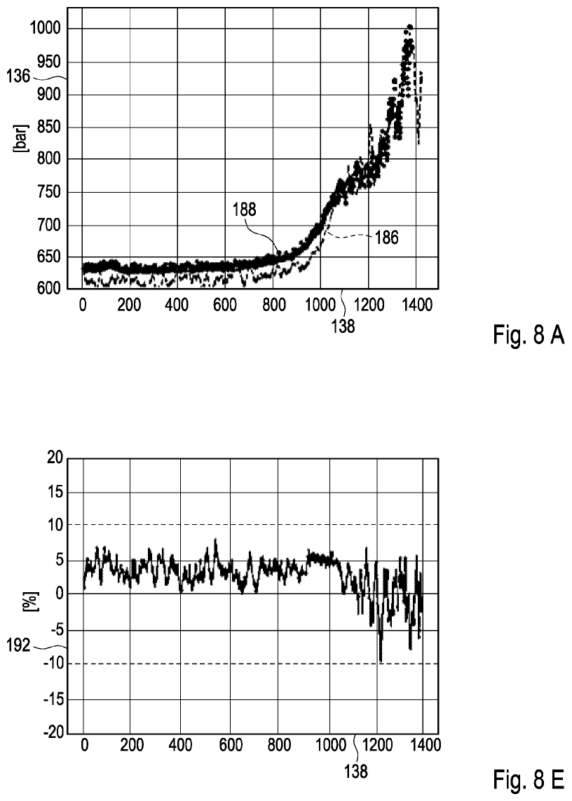

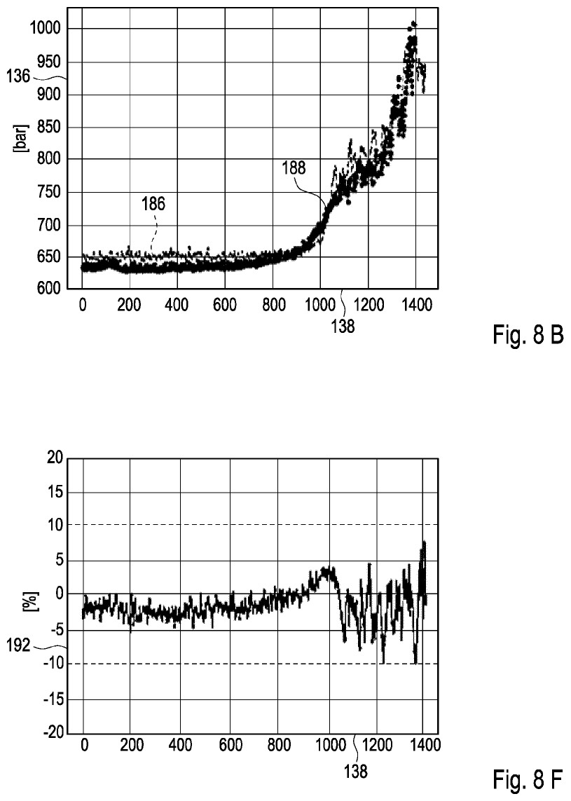

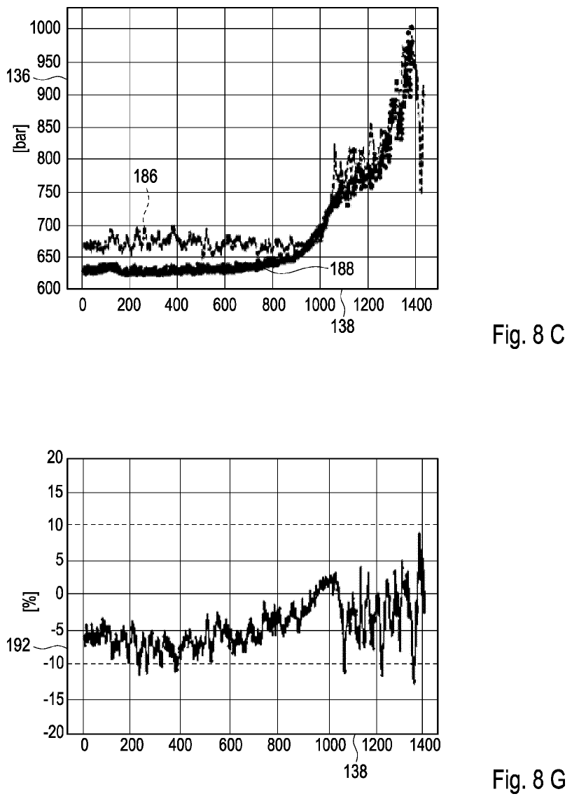

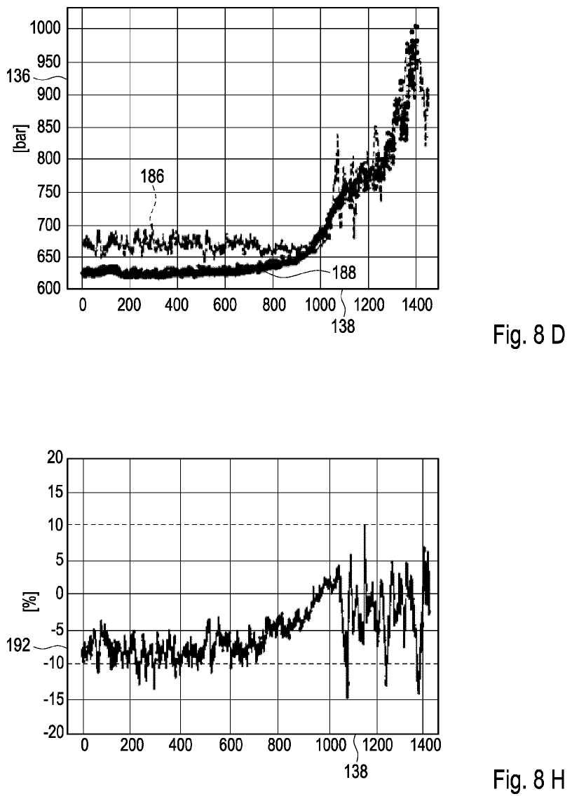

FIGS. 8A to 8H show diagrams of exemplary results of the method 140 for determining lifetime with the data driven model comprising a first machine learning model. The results shown in FIGS. 8A to 8H may be obtained when performing the method 140 according to the present invention, for example according to any one of the exemplary embodiments discussed referring to FIGS. 3 to 5.

In the example of FIGS. 8A to 8H, as an alternative to the linear model or in addition, a more complex model may be used such as a neural network. For example, the neural network may be a recurrent neural network (RNN). The RNNs may be designed for receiving multiple input features simultaneously to calculate a pressure prediction, also denoted as pressure forecast. This may allow increasing the model performance significantly. For example, the state variable is pressure at injection 136 and as model input chromatography data retention time, pressure maximum, pressure difference at start and end of a chromatogram may be used.

FIGS. 8A to 8D show the pressure at injection 136 as a function of the number of injections 138. Therein, mean of predicted pressure at injection 186 and observed pressure at injection 188 are shown in a combined diagram. In FIGS. 8E to 8H, diagrams of relative errors 192 on the results of FIGS. 8A to 8D are shown. Specifically, the relative error 192 may be obtained by comparing the mean of the predicted pressure 186 with the observed pressure 188 as a function of the number of injections 138. The relative error 192 of FIG. 8E corresponds to the prediction of FIG. 8A, the relative error 192 of FIG. 8F corresponds to the prediction of FIG. 8B, the relative error 192 of FIG. 8G corresponds to the prediction of FIG. 8C and the relative error 192 of FIG. 8H corresponds to the prediction of FIG. 8D. Further, FIGS. 8A and 8E are shown for a training with a total number of 50 epochs, FIGS. 8B and 8F are shown for a training with a total number of 100 epochs, FIGS. 8C and 8G are shown for a training with a total number of 200 epochs and FIGS. 8D and 8H are shown for a training with a total number of 300 epochs.

In the example of FIGS. 8A to 8H, the data driven model was trained on at least one training dataset. The training dataset may comprise historical data of at least one known chromatography column configuration. The historical data may comprise at least one feature, specifically a plurality of features derived from input variables such as standard deviation, mean absolute deviation, median, quantiles and the like, and/or from metadata. For example, the historical data comprises operating data of one or more of: pressure curve, maximum pressure, pressure difference at start and end of a chromatogram, peak width, retention time, peak symmetry. The method 140 may comprise generating the at least one training data set and determining parameters of the data driven model by training the data driven model with the training data. For example for training, available historic data may be subdivided into data which is used for parameter determination, i e. denoted as training data set, test dataset and validation dataset. The validation dataset may be a dataset used to tune hyperparameters. The test dataset may comprise historic data independent of the training dataset. The test dataset may be used for testing the model which was trained on the training data set. Such procedures are generally known to the skilled person. The parameters may be determined using at least one optimization algorithm. The data driven model may be a self-learning model. The method 140 may comprise updating the data driven model considering the received model input chromatography data and the determined state variable. The training of the model may comprise continuous training, for example using incoming data for further optimizing the model.

For example, the data driven model may comprise at least two Long short-term memory (LSTM) layers. The data driven model may comprise a single output node. For example, each of the LSTM layers may be designed with 25 hidden units. The window size may be fixed to 20 input values and a varying number of input features. For example, training was done using an adam optimization algorithm, a batch size of 32 samples and total number of 50 to 300 epochs. Five training columns with a total number of 2305 samples were used as a training set. As can be seen in the FIGS. 8A to 8H, training may preferably be stopped at a low total number of epochs, specifically at a number of below 200 epochs, more specifically at 100 epochs, in order to avoid overfitting of the machine learning model.

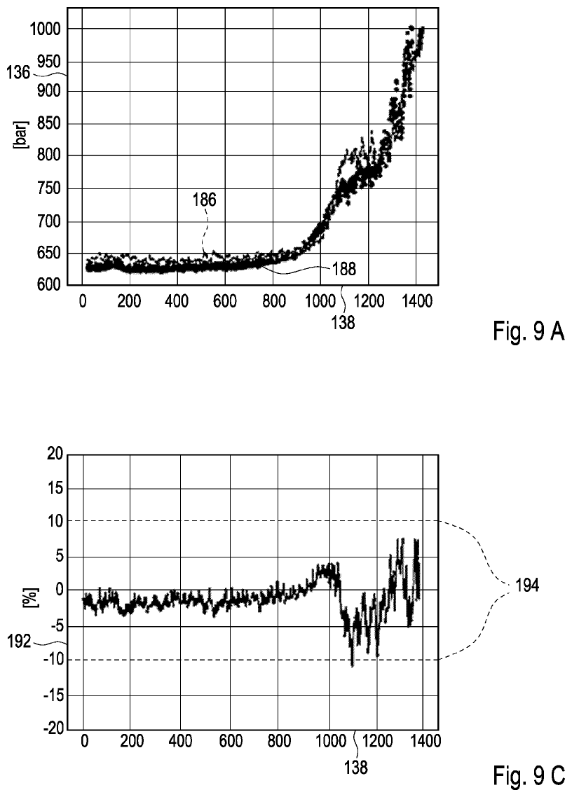

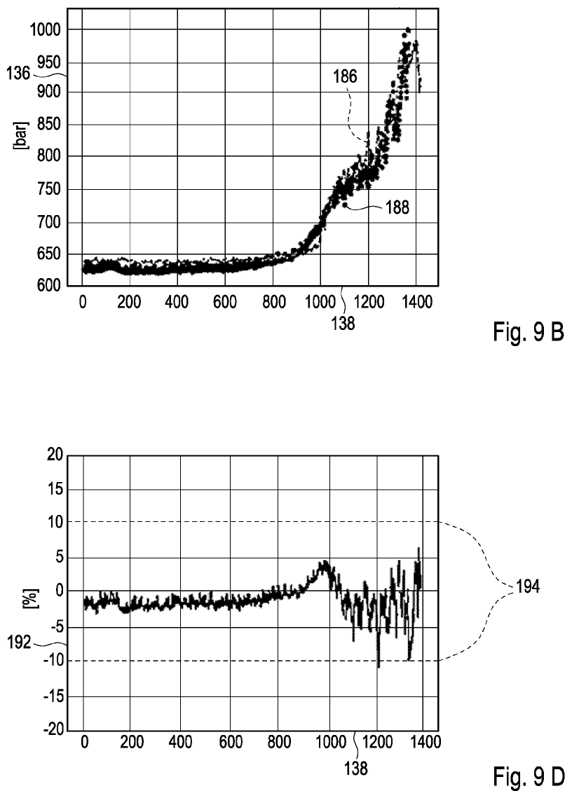

FIGS. 9A to 9D show diagrams of exemplary results of the method 140 for determining lifetime with the data driven model comprising a second machine learning model. The results shown in FIGS. 9A to 9D may be obtained when performing the method 140 according to the present invention, for example according to any one of the exemplary embodiments discussed referring to FIGS. 3 to 5.

In the example of FIGS. 9A to 9D, as an alternative to the machine learning model described with reference to FIGS. 8A to 8H, the data driven model may comprise at least two LSTM layers. A first LSTM layer may be used as encoder layer and a second LSTM layer may be used as decoder layer. The first LSTM layer, e.g. designed with 25 hidden units, may be used as an encoder of the input window. The data driven model may further comprise at least one attention layer, wherein the attention layer may be designed for weighing hidden states in the encoder layer. The output of this layer may be fed into the second LSTM layer which serves as a decoder and outputs a sequence of time steps, e.g. of 50 time steps. The window size may be fixed to 20 input values and a varying number of input features. For example, training was done using an adam optimization algorithm, a batch size of 32 samples and total number of 50 (FIGS. 9A and 9C) and 100 epochs (FIGS. 9B and 9D). Five training columns with a total number of 2305 samples were used as a training set.

Again, FIGS. 9A and 9B show the pressure at injection 136 as a function of the number of injections 138. Therein, mean of predicted pressure at injection 186 and observed pressure at injection 188 are shown in a combined diagram. In FIGS. 9C and 9D, diagrams of relative errors 192 on the results of FIGS. 9A and 9B are shown, wherein the relative error 192 of FIG. 9C corresponds to the prediction of FIG. 9A and the relative error 192 of FIG. 9D corresponds to the prediction of FIG. 9B. The relative error 192 may be obtained by comparing the mean of the predicted pressure 186 with the observed pressure 188 as a function of the number of injections 138. As can be seen in FIGS. 9C and 9D, the relative errors 192 are within the range of ±10%.

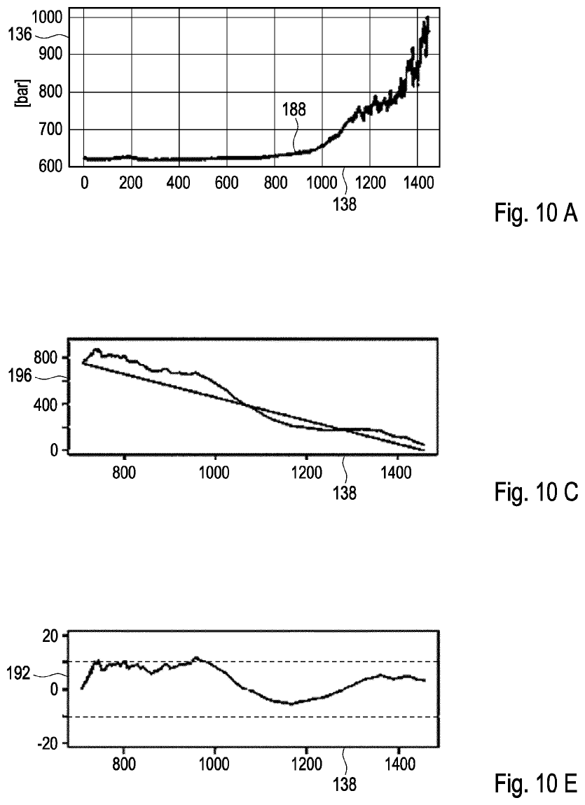

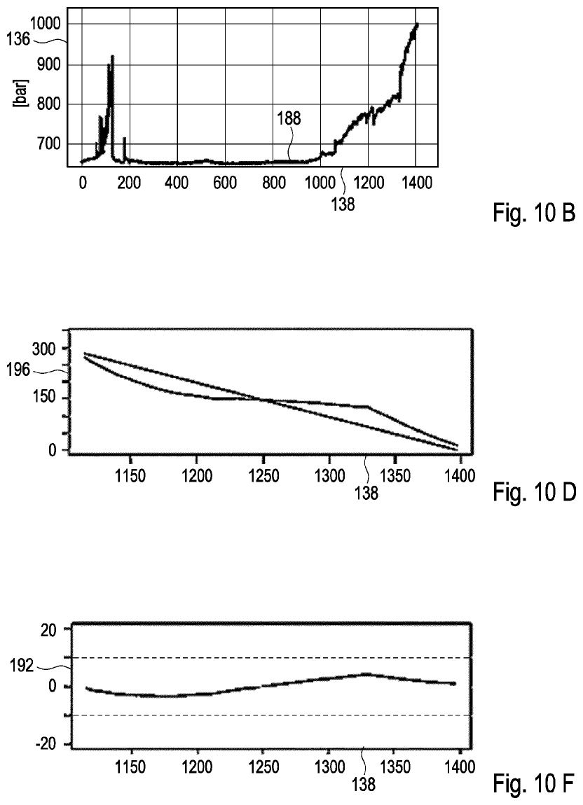

In FIGS. 10A to 10F, diagrams of exemplary results on information about lifetime of the chromatography column 116 obtained by performing the method 140 for determining lifetime are shown. The results shown in FIGS. 10A to 10F may be obtained when performing the method 140 according to the present invention, such as according to any one of the exemplary embodiments discussed referring to FIGS. 3 to 5 or according to any other possible embodiment, specifically with the data driven model comprising at least one machine learning model.

In FIGS. 10A and 10B, the pressure at injection 136 is shown as a function of the number of injections 138. Specifically, the observed pressure at injection 188 is shown in these diagrams. FIGS. 10C and 10D show the predicted remaining useful lifetime 196 as a function of the number of injections 138. FIGS. 10E and 10F show relative errors 192, wherein the relative error 192 of FIG. 10E corresponds to the prediction of FIG. 10C and the relative error 192 of FIG. 10F corresponds to the prediction of FIG. 10D. The relative error 192 may be obtained by comparing the mean of the predicted pressure 186 with the observed pressure 188 as a function of the number of injections 138. As can be seen in FIGS. 10E and 10F, the relative errors 192 are within the range of ±10%.

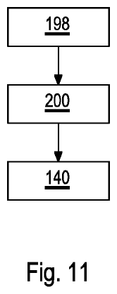

FIG. 11 shows a flow chart of an exemplary embodiment of a method for operating the chromatography column 116. The method comprises the following steps which, as an example, may be performed in the given order. It shall be noted, however, that a different order is also possible. Further, it is also possible to perform one or more of the method steps once or repeatedly. Further, it is possible to perform two or more of the method steps simultaneously or in a timely overlapping fashion. The method may comprise further method steps which are not listed.

The method comprises the following steps:
(a) (denoted by reference number 198) performing a multitude of chromatographic separations of samples on said chromatography column 116;
(b) (denoted by reference number 200) providing model input chromatography data for at least a fraction of said chromatographic separations; and
(c) (denoted by reference number 140) determining lifetime of said chromatography column 116 according to the method 140 for determining lifetime according to the present invention.

For example, step a) may comprise applying a sample and at least one column void volume, in a further example at least one column volume, of mobile phase onto said chromatography column 116. The step may further comprise applying further mobile phase, a mobile phase gradient and/or applying steps of re-equilibration to the chromatography column 116. Also, the step may include detection of one or more analyte(s) after separation by means known to the skilled person, and/or collection of one or more fraction(s) for further analysis. The step may also comprise performing mass spectrometry 122 on at least part of the eluate from the chromatography column 116.

Use of said chromatography column 116 may be discontinued or modified in case said lifetime exceeds a threshold, e.g. in case the determined lifetime is outside a pre-defined reference range or is beyond a threshold.

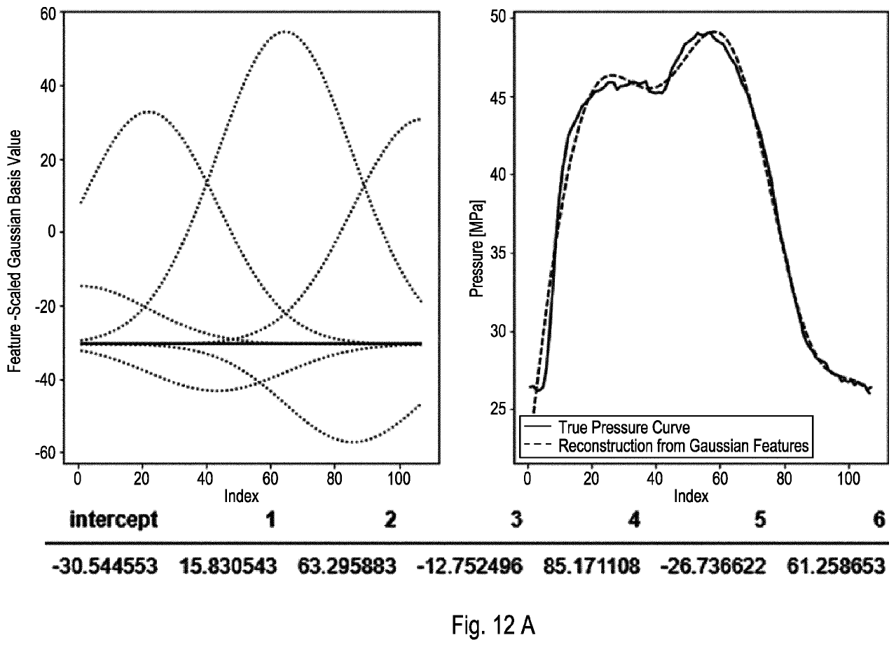

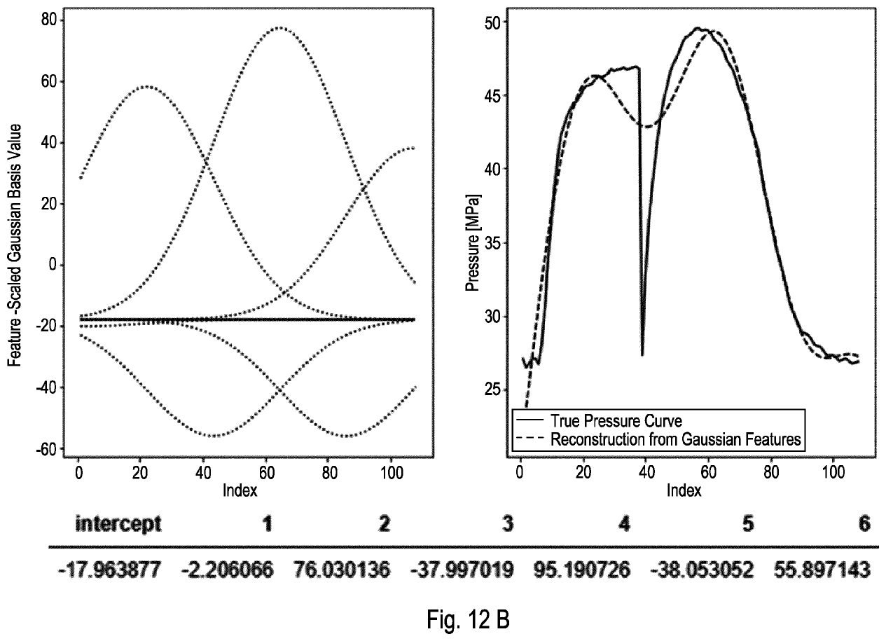

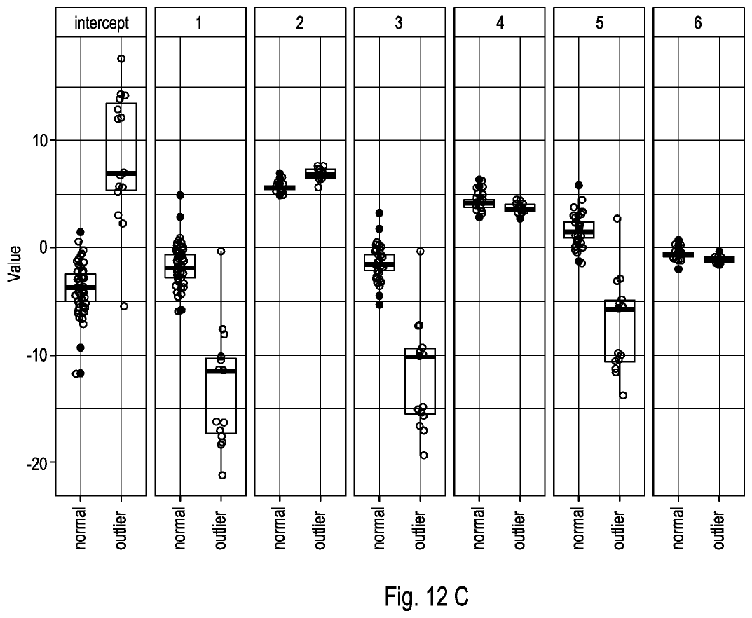

FIGS. 12A to C show experimental results for estradiol. The following experimental conditions were used for the High Pressure Liquid Chromatography (LC) method used for FIGS. 12A to C:

| Pressure Curve | Mixture A* | Mixture B** | Flow Rate |
|---|---|---|---|
| Index | Mixing Rate [%} | Mixing Rate [%] | [μl/min] |
| 0 | 61.0 | 39.0 | 440 |
| 36 | 61.0 | 39.0 | 440 |
| 72 | 10.0 | 90.0 | 440 |
| 78 | 2.0 | 98.0 | 440 |
| 108 | 2.0 | 98.0 | 440 |

with *100% H20 and **97% MeOH, 3% VB4 Ammonium Fluoride in MeOH.

Gaussian feature generation may be performed as follows: Arbitrary functions (such as pressure curves) can be approximated using finite basis function expansion,

$${β}_{0} + {\sum }_{i = 1}^{n} {β}_{i} {B}_{i} ( x )$$

For single pressure curves Gaussian basis functions may be used:

$${B}_{i} ( x ) = exp ( - \frac{{( x - {μ}_{i} )}^{2}}{2 w} )$$

The grid of i=1, . . . , n Gaussian functions on a (discrete) domain [a, b] may be defined through:

$$w = \frac{b - a}{n - 1} , n > 1 \\ and \\ {μ}_{i} = a + ( i - 1 ) w .$$

Since the finite basis function expansion defined above can be regarded as a linear regression model, in FIGS. 12, reference is made to the coefficient β₀ as “intercept” and to the n basis function coefficients β₁, . . . , βₙ simply as “1”, . . . , “n”. The joint set of all coefficients β that is determined by this approach is referred to as “Gaussian features”.

FIG. 12A shows for normal estradiol the feature scaled Gaussian basis value (left plot) and pressure in [MPa] (right plot) as a function of the index. The bottom table shows the intercept. FIG. 12A depicts in the bottom table and the left plot that a low number of Gaussian Features is able to approximate the high-dimensional pressure data to allow a sufficient reconstruction of its salient characteristics (right plot).

FIG. 12B shows for outlier estradiol the feature scaled Gaussian basis value (left plot) and pressure in [MPa] (right plot) as a function of the index. The bottom table shows the intercept. FIG. 12B depicts that in the case of an abnormal pressure curve (right plot) the Gaussian feature values change significantly (bottom table and left plot) compared to the normal pressure curve in the previous plot. Thus, this property can be exploited for outlier detection.

FIG. 12 C shows an exemplary outlier detection using Gaussian Features. Normal and outlying pressure curves can be distinguished in the Gaussian feature space since their feature values differ strongly. This allows classification using rather simple multivariate methods (e.g. Logistic Regression or Random Forests).

### LIST OF REFERENCE NUMBERS

110 chromatography device
112 test system
114 liquid chromatography device
116 chromatography column
118 interface
120 interface
122 mass spectrometry device
124 quadrupole mass spectrometry device
126 ionization source
128 communication interface
130 processing device
132 user interface
134 chromatography data
136 pressure at injection
138 number of injections
140 method for determining lifetime
142 receiving model input chromatography data
144 determining at least one state variable
146 evaluating the determined state variable
148 providing information about lifetime
150 receiving raw chromatography data
152 data preparation step
154 feature extraction or deriving step
156 determining a derivative
158 determining a linear prediction
160 determining a “mean” and/or a standard deviation
162 feeding the model input chromatography data into the data driven model and computing a lifetime prediction
164 arrow
166 start
168 setting i=0 and retrieving metadata
170 increasing the variable
172 decision node
174 removing and/or imputing the outlier
176 decision node
178 decision node
180 stop
182 decision node
184 predicted pressure at injection
186 mean of predicted pressure at injection
188 observed pressure at injection
190 probability of failure
192 relative error
194 dashed line
196 remaining useful lifetime
198 performing a multitude of chromatographic separations
200 providing model input chromatography data

1. A computer implemented method for determining a lifetime of a chromatography column of a chromatography device, wherein the method comprises:
receiving model input chromatography data via at least one communication interface, wherein the model input chromatography data comprises multiple inputs;
determining at least one state variable indicative of a lifetime of the chromatography column using at least one data driven model based on the model input chromatography data using at least one processing device; and
evaluating the determined at least one state variable thereby determining information about lifetime by using the processing device, wherein the evaluation comprises comparing the determined at least one state variable to at least one threshold.

2. The method of claim 1, further comprising predicting the lifetime of the chromatography column over a plurality of subsequent chromatographic separations.

3. The method of claim 1, wherein the model input chromatography data comprises a plurality of input parameters selected from the group consisting of a maximum pressure, a pressure difference at a start and an end of a chromatogram, a peak width, a retention time, a peak symmetry, a sample type, an assay type of each measurement, a usage time of the chromatography column on the chromatography device, at least one maintenance parameter, and a change of the chromatography column.

4. The method of claim 1, wherein the model input chromatography data comprises metadata relating to one or more of at least one chromatography column production factor and at least one laboratory specific factor.

5. The method of claim 1, wherein the at least one state variable is at least one state variable selected from the group consisting of a maximum pressure, a pressure difference at a start and an end of a chromatogram, a peak width, a retention time, and a peak symmetry.

6. The method of claim 1, wherein the at least one data driven model comprises one or more of at least one linear model, at least one non-linear model, at least one machine learning model, and at least one time series model.

7. (canceled)

8. The method of claim 1, wherein the at least one data driven model comprises a recurrent neural network, the at least one state variable comprises a pressure at injection, and the model input chromatography data comprises a retention time, a pressure maximum, and a pressure difference at a start and an end of a chromatogram.

9. (canceled)

10. The method of claim 1, wherein the information about lifetime comprises one or more of a probability of failure, a pressure at future time points, a remaining useful lifetime, and/or at least one output recommendation for the chromatography column.

11. The method of claim 1, further comprising providing the information about lifetime via at least one user interface in response to determining that a value of the determine at least one state variable exceeds the at least one threshold.

12. (canceled)

13. (canceled)

14. A method for operating a chromatography column, the method comprising:
performing, by a chromatography device, a plurality of chromatographic separations of samples on said chromatography column;
providing, by the chromatography device, model input chromatography data for at least a fraction of said plurality of chromatographic separations;
receiving, by a chromatography test system, the model input chromatography data via at a communication interface, wherein the model input chromatography data comprises multiple inputs;
determining, by the chromatography test system, at least one state variable indicative of a lifetime of the chromatography column using at least one data driven model based on the model input chromatography data;
comparing, by the chromatography test system, the determined at least one state variable to at least one reference threshold;
determining, by the chromatography test system, lifetime information corresponding to the chromatography column based on the comparison of the determined at least one state variable to the at least one reference threshold; and
providing, by the chromatography test system and to a user interface, the determined lifetime information corresponding to the chromatography column.

15. The method of claim 14, wherein a use of said chromatography column is discontinued or modified in response to a determination that a determined lifetime of the chromatography column exceeds a threshold.

16. The method of claim 1, further comprising initializing at least one maintenance process in response to determining that a value of the determined at least one state variable exceeds the at least one threshold.

17. The method of claim 16, wherein initializing the at least one maintenance process comprises initializing an action for handling the chromatography column and/or initializing an action for handling a sample to be analyzed.

18. The method of claim 8, wherein the recurrent neural network of the at least one data driven model comprises a first short-term memory (LSTM) layer and a second LSTM layer, the first LSTM layer is used as encoder layer and the second LSTM layer is used as decoder layer; and
wherein the at least one data driven model further comprises at least one attention layer for weighing hidden states in the first LSTM layer, wherein an output of the at least one attention layer is fed into the second LSTM layer which outputs a sequence of time steps.

19. The method of claim 2, wherein predicting the lifetime of the chromatography column over a plurality of subsequent chromatographic separations comprises predicting the lifetime of the chromatography column over 5 subsequent chromatographic separations, over 10 subsequent chromatographic separations, or over 35 subsequent chromatographic separations.

20. The method of claim 1, wherein the at least one data driven model comprises at least one recurrent neural network.

21. The method of claim 1, wherein the at least one data driven model comprises at least one long-short-term-memory (LSTM), at least one gated recurrent units (GRU), and/or at least one convolutional neural network (CNN).

22. The method of claim 1, wherein the at least one data driven model comprises at least one long-term recurrent convolutional Network (LRCN).

23. The method of claim 1, wherein the at least one data driven model comprises at least one fractional polynomial model.

24. A chromatography test system for determining a lifetime of a chromatography column, the chromatography test system comprising:
at least one processor; and
at least one memory comprising a plurality of instructions stored thereon that, in response to execution by the at least one processor, causes the chromatography test system to:
receive model input chromatography data via at least one communication interface, wherein the model input chromatography data comprises multiple inputs;
determine at least one state variable indicative of a lifetime of the chromatography column using at least one data driven model based on the model input chromatography data; and
evaluate the determined at least one state variable to determine information about lifetime of the chromatography column, wherein the evaluation comprises a comparison of the determined at least one state variable to at least one threshold.
